(19) United States
(12) Patent Application Publication
(10) Pub. No.: US 2008/0007484 A1
(43) Pub. Date: Jan. 10, 2008

(54) Option display device, option display method, and computer product

(75) Inventor: Tomoya Iwakura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/638,391

(22) Filed: Dec. 14, 2006

(30) Foreign Application Priority Data
Jul. 10, 2006 (JP) 2006-189814

(51) Int. Cl. G09G 5/00

(52) U.S. Cl. 345/5

(57) ABSTRACT

In an information processing device, a display control unit arranges one of options at a predetermined center position, while arranging others radially around the center option, and displays the options in a selectable manner. Before a user provides input through an input unit by operating an arrow key, a cursor is placed on the center option. The options are displayed in a matrix, and the cursor is initially placed and displayed in the center of the matrix.

### BACKGROUND OF THE INVENTION

1. Field of the Invention

The present invention relates to an option display device, an option display method, and a computer product.

2. Description of the Related Art

When a terminal device such as a personal computer and a cellular phone receives an instruction to convert kana (hiragana and katakana) characters (Japanese phonetic characters) to kanji characters (Chinese ideographic characters), or when autocomplete is performed for an input letter, several options are displayed in a selectable manner. For example, Japanese Patent Application Laid-open No. H1-158560 (FIG. 1B on Page 4) discloses such a technology, in which several options are displayed in a matrix 1 as shown in FIG. 40.

In general, such a terminal device displays several options in a list of a single row, a list of a single column, or a matrix in a selectable manner. The option at the top of the list or in the first row and the first column is initially displayed as an option most likely to be selected (hereinafter, “likely option”) and distinguished from others. Then, in response to input to change the likely option, the likely option is changed to another in the list, and the option currently indicated as a likely option is distinguishably displayed.

For example, as shown in FIG. 41, when 10 options are displayed in a single column to transliterate a word from kana to kanji, a kanji option at the top of the column is displayed with a selection cursor 2 placed thereon so that the option is distinguished from others as the first likely option. If the user moves the selection cursor 2 by, for example, pressing the down-arrow key on the keyboard, the likely option is changed. In this case, with nine times of pressing the down-arrow key, the selection cursor 2 is moved onto a kanji option at the bottom of the column. The kanji option is displayed as a currently designated likely option and distinguished from other options.

In the conventional technology, however, options are arranged at different distances from the one primarily displayed as the first likely option. The user therefore may need several times of input operations, which reduces the operability of the device. For example, in FIG. 41, when the user wishes to select the second option from the top out of the 10 options, only a single input operation is required. On the other hand, when the option at the bottom of the column is to be selected, the input operation needs to be repeated nine times, as explained above, to move the selection cursor 2 from the top to the bottom.

### SUMMARY OF THE INVENTION

It is an object of the present invention to at least partially solve the problems in the conventional technology.

According to an aspect of the present invention, an option display device that displays a plurality of options in a selectable manner such that one of the options is distinguishable from others as a specific option while changing the specific option in response to a select input to select an option received through an input unit, includes an option arranging unit that arranges a first option from among the options at substantially center of other options, and a display unit that displays the first option as the specific option when the select input is first received through the input unit.

According to another aspect of the present invention, an option display method for displaying a plurality of options in a selectable manner such that one of the options is distinguishable from others as a specific option while changing the specific option in response to a select input to select an option, includes arranging a first option from among the options at substantially center of other options, and displaying the first option as the specific option when the select input is first received.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the overview and features of an information processing device according to a first embodiment;

FIG. 2 is a block diagram of the information processing device according to the first embodiment;

FIG. 3 is a schematic for explaining a process of creating a list performed by a list creating unit shown in FIG. 2;

FIG. 4 is a schematic for explaining a process of creating a table performed by a table creating unit shown in FIG. 2;

FIG. 5 is another schematic for explaining the process of creating the table performed by the table creating unit;

FIG. 6 is a flowchart of an option display control process according to the first embodiment;

FIG. 7 is a schematic for explaining a process of arranging options on the table performed by an option arranging unit shown in FIG. 2;

FIGS. 8 to 10 are examples of a screen display of an output unit shown in FIG. 2;

FIG. 11 is a block diagram of an information processing device according to a second embodiment;

FIG. 12 is an example of information stored in a policy storage unit shown in FIG. 11;

FIGS. 13 to 15 are schematics for explaining a process of assigning the order of arrangement to a table performed by an option arranging unit shown in FIG. 11;

FIG. 16 is a flowchart of an option display control process according to the second embodiment;

FIG. 17 is a schematic for explaining a process of arranging options on the table performed by the option arranging unit;

FIG. 18 is a schematic for explaining a process of creating a list performed by a list creating unit according to a third embodiment;

FIG. 19 is a flowchart of an option display control process according to the third embodiment;

FIG. 20 is a schematic for explaining a case of applying an information processing device of the third embodiment to a vehicle navigation system;

FIG. 21 is another schematic for explaining a case of applying the information processing device to a vehicle navigation system;

FIG. 22 is an example of a screen display of an output unit according to a fourth embodiment;

FIG. 23 is an example of contents of a list created by a list creating unit according to a fifth embodiment;

FIG. 24 is an example of a table with attributes according to the fifth embodiment adds;

FIG. 25 is a flowchart of an option display control process according to the fifth embodiment;

FIG. 26 is a schematic for explaining a process of arranging the options to the table performed by an option arranging unit according to the fifth embodiment;

FIG. 27 is an example of a screen display of an output unit according to the fifth embodiment;

FIG. 28 is a block diagram of an information processing device according to a sixth embodiment;

FIG. 29 is an example of information stored in a three-dimensional policy storage unit shown in FIG. 28;

FIG. 30 is a schematic for explaining a process of creating lists performed by a list creating unit shown in FIG. 28;

FIG. 31 is a flowchart of an option display control process according to the sixth embodiment;

FIGS. 32 to 37 are examples of a screen display of an output unit shown in FIG. 28;

FIGS. 38A to 38C are examples of a table according to a modified embodiment of the present invention;

FIGS. 39A to 39C are examples of a selection cursor according to a modified embodiment of the present invention;

FIG. 40 is an example in which options are displayed according to a conventional technology;

FIG. 41 is an example of a conventional selection cursor; and

FIG. 42 is a block diagram of a computer that executes an option display program.

### DETAILED DESCRIPTION OF THE PREFERRED EMBODIMENTS

Exemplary embodiments of the present invention will be explained in detail below with reference to the accompanying drawings.

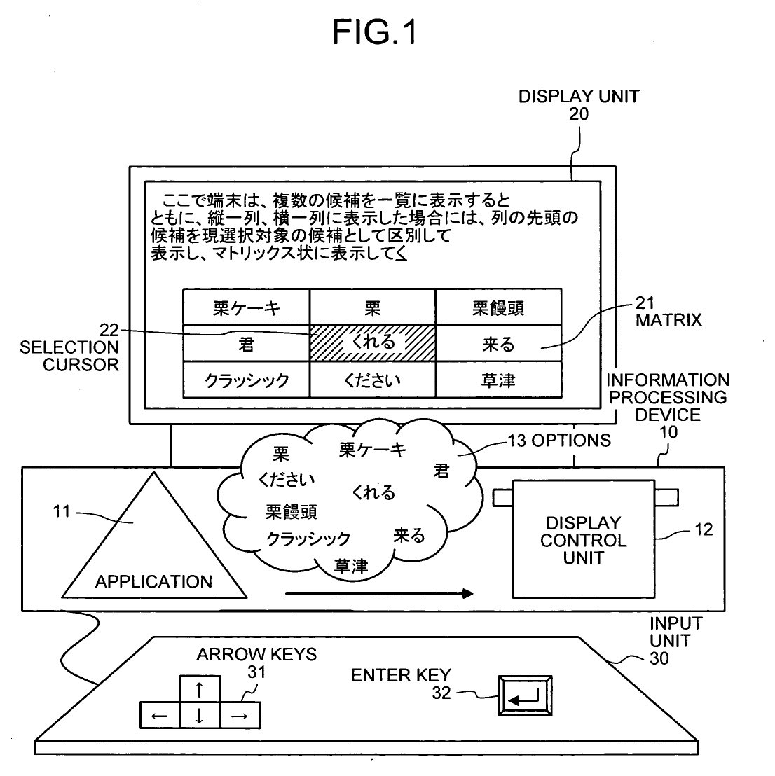

FIG. 1 is a schematic for explaining the overview and features of an information processing device 10 according to the first embodiment.

The information processing device 10 displays multiple options on a display unit 20 such that an option that is currently specified as a likely option is distinguishable from others while changing the likely one of the options in response to input received through an input unit 30.

In FIG. 1, when options are generated upon input of a letter, a display control unit 12 of the information processing device 10 displays the options on the display unit 20 with a specific one of them at the center and others around the specific option. The specific option arranged at the center is displayed distinguishably from the others as a likely option before the user first provides input through the input unit 30 to select an option.

Specifically, when a user inputs as information a kana letter through the input unit 30, an application 11 of the information processing device 10 generates, with its autocomplete function, nine options 13 of words starting with the kana letter. Then, the display control unit 12 displays the nine options 13 on the display unit 20 in a 3×3 matrix 21 with a specific option at the center. The specific option is displayed at the center of the matrix 21 as the first likely option with a selection cursor 22 placed thereon, until the user first operates arrow keys 31 to provide input to move the selection cursor 22 through the input unit 30. The arrow keys 31 include up, down, left, and right arrow keys. In response to the input, the information processing device 10 moves the selection cursor 22 at the center of the matrix 21 onto an option positioned in a direction indicated by the input. When an enter key 32 is pressed, the information processing device 10 selects the option that is currently designated as a likely option, i.e., the option on which the selection cursor 22 resides, and displays a word corresponding to the option in text.

In this manner, respective options are arranged at nearly the same distance from an option initially specified as a likely option, and fewer operations are required to change the likely option to another. In other words, with the matrix 21, the user can select any option by pressing any of the arrow keys 31 twice at most. Thus, the user can change the likely option with less presses of the arrow keys 31. As a result, the information processing device 10 can facilitate user operation to select an option.

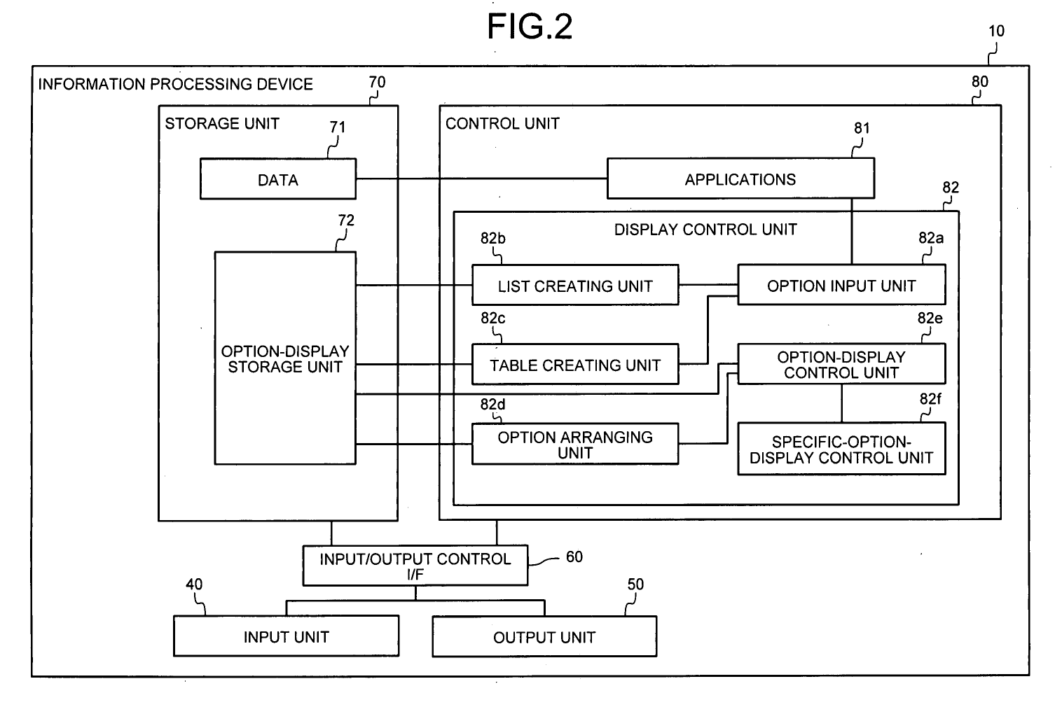

FIG. 2 is a block diagram of the information processing device 10. The information processing device 10 includes an input unit 40, an output unit 50, an input/output control interface (I/F) 60, a storage unit 70, and a control unit 80.

The input unit 40 includes a keyboard, a mouse and the like, and receives various types of information and commands. More specifically, the input unit 40 receives from the user a series of commands (to move the selection cursor, select an option, etc.) until a display control unit 82, explained later, selects the option. The input unit 40 also receives from the user information necessary to execute various applications 81.

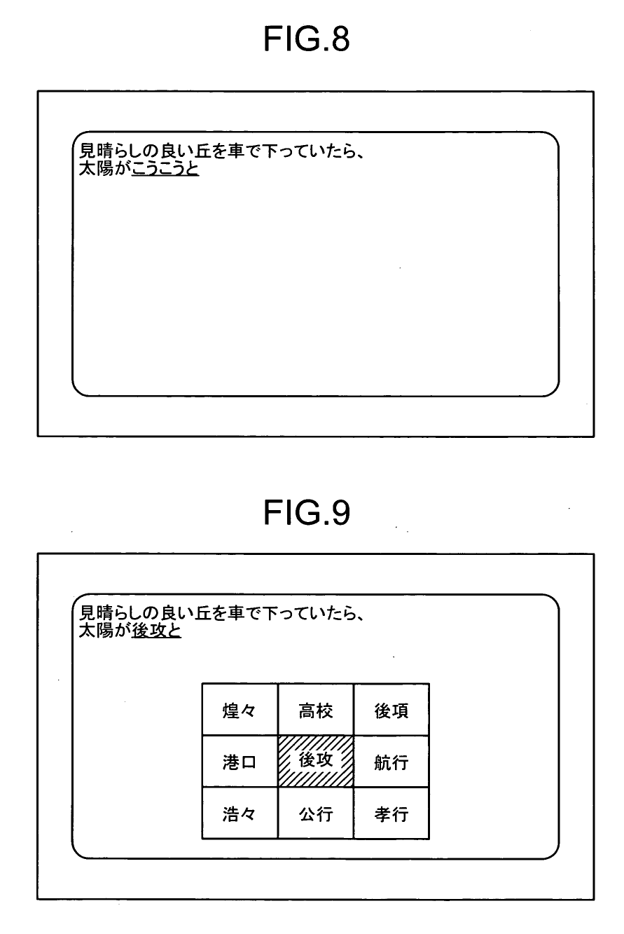

The output unit 50 includes a display, a monitor and the like, and outputs the results of various processes. More specifically, the output unit 50 displays a display screen to execute the applications 81, and a list of options that the display control unit 82 receives from the applications 81 (see FIGS. 8 to 10).

The input/output control I/F 60 controls data transfer from the input unit 40 and the output unit 50 to the storage unit 70 and the control unit 80 and vice versa.

The storage unit 70 stores therein data and programs necessary for various processes performed by the control unit 80. Particularly, the storage unit 70 includes an option-display storage unit 72, and stores therein various types of data 71 used by the applications 81.

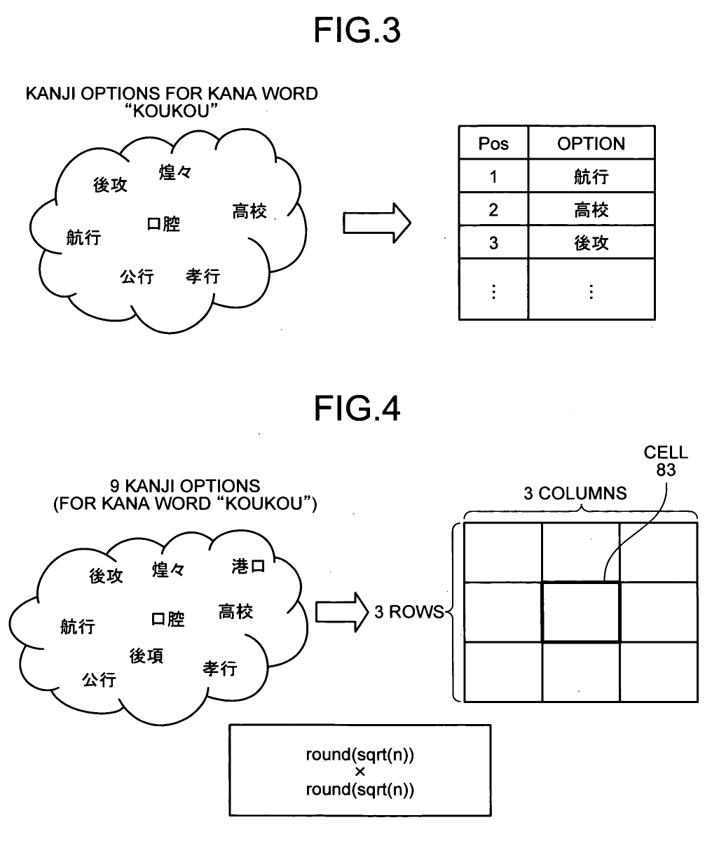

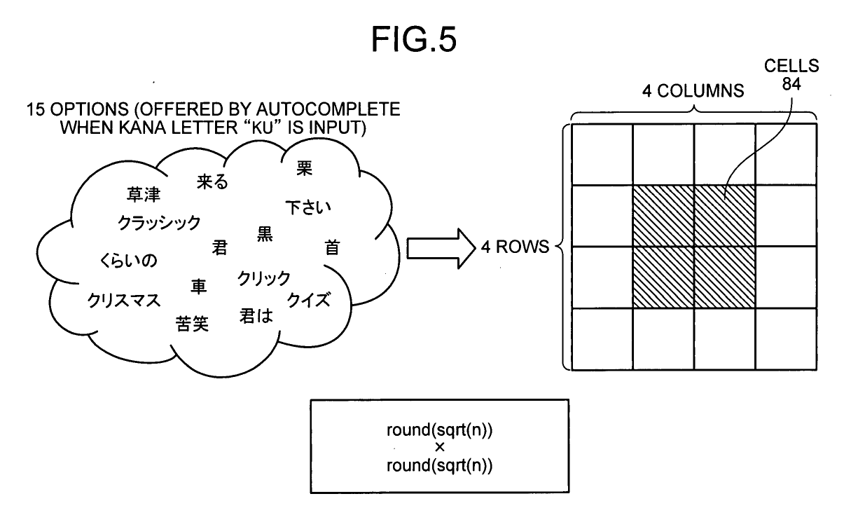

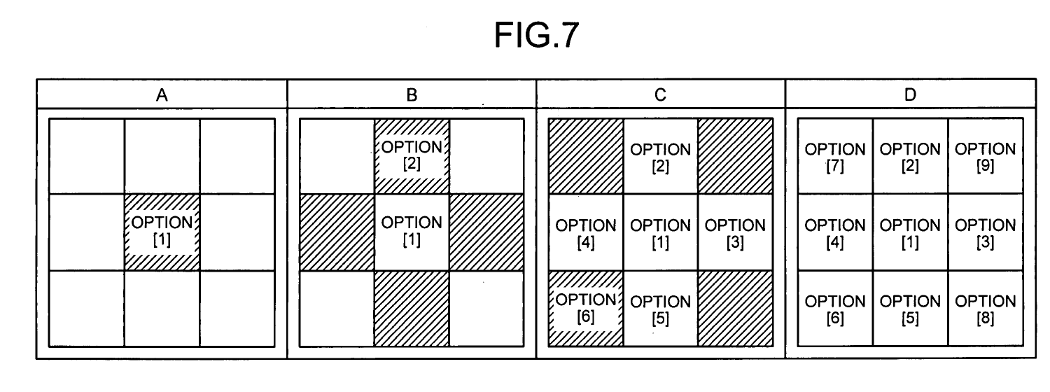

The option-display storage unit 72 stores therein data necessary for the display control unit 82 to perform various processes. More specifically, the option-display storage unit 72 temporarily stores therein a list created by a list creating unit 82b (see FIG. 3), a table created by a table creating unit 82c (see FIGS. 4 and 5), a table on which options are arranged by an option arranging unit 82d (see FIG. 7), described later, and the like.

The control unit 80 controls the information processing device 10 to perform various processes. Particularly, the control unit 80 is installed with the applications 81, and includes the display control unit 82.

The applications 81 are application software executed for different types of jobs and different purposes. When multiple options are generated during the execution of the applications 81, the options are output to an option input unit 82a. More specifically, when word-processing software is executed and multiple options are generated through kana-to-kanji conversion, the options are output to the option input unit 82a.

The display control unit 82 displays multiple options in a browsable manner on the output unit 50 such that an option currently specified as a likely option is distinguishable from others while changing the likely one of the options in response to input received through the input unit 40. The display control unit 82 includes the option input unit 82a, the list creating unit 82b, the table creating unit 82c, the option arranging unit 82d, an option-display control unit 82e, and a specific-option-display control unit 82f.

The option input unit 82a receives multiple options generated by the applications 81. More specifically, upon receiving several options from word-processing software or the like, the option input unit 82a outputs the options to the list creating unit 82b, and also outputs information on the number of options to the table creating unit 82c. For example, having received nine kanji options generated when a word “koukou” is converted from kana to kanji, the option input unit 82a outputs the kanji options to the list creating unit 82b, and information on the number of options: 9 to the table creating unit 82c.

The list creating unit 82b creates a list based on the options received from the option input unit 82a, and stores the list in the option-display storage unit 72. FIG. 3 is a schematic for explaining the process of creating a list performed by the list creating unit 82b. Upon receiving options from the option input unit 82a, the list creating unit 82b creates a list in which the respective options are associated with identification information (information to be processed by the option arranging unit 82d, preferably serial numbers starting with 1), and stores the list in the option-display storage unit 72. For example, the list creating unit 82b creates a list of kanji options, as shown in FIG. 3, for the kana word “koukou”, in which sequential numbers (1, 2, 3, . . . ) are assigned to the kanji options, respectively. The list is stored in the option-display storage unit 72.

The table creating unit 82c creates a table based on the information on the number of options received from the option input unit 82a, and stores the table in the option-display storage unit 72. More specifically, upon receiving the information from the option input unit 82a, the table creating unit 82c creates a table in which cells are arranged in a matrix based on the information, and determines a center cell to be used in a process performed by the option arranging unit 82d. The table is stored in the option-display storage unit 72.

FIGS. 4 and 5 are schematics for explaining the process of creating a table performed by the table creating unit 82c. For example, having received the information indicating that there are nine kanji options for the kana word “koukou”, the table creating unit 82c creates a 3×3 table that can contain the kanji options, as shown in FIG. 4, with a function (round(sqrt(n))×round(sqrt(n))) stored in the option display storing unit 72. In the function, sqrt(n) is a function that computes the square root of n, and round(sqrt(n)) is a function that rounds the decimal of sqrt(n) to the nearest whole number. The table creating unit 82c substitutes a value indicated by the information for n and creates a table that can contain n options. Then, the table creating unit 82c determines a cell 83 in the second row and the second column as the center cell. The table is stored in the option-display storage unit 72.

For another example, when 15 options for a word starting with a kana letter “ku” are generated with the autocomplete function as shown in FIG. 5, the table creating unit 82c receives the information indicating 15. In the same manner as above, the table creating unit 82c creates a 4×4 table that can accommodate 16 options. In this case, the center cell cannot be uniquely determined, and any one of four cells 84 that are shaded is determined as the center cell. The table is stored in the option-display storage unit 72.

The option arranging unit 82d arranges a specific option in a predetermined center cell, and other options are arranged radially around the center cell. More specifically, the option arranging unit 82d retrieves the list created by the list creating unit 82b and the table created by the table creating unit 82c from the option-display storage unit 72. Then, the option arranging unit 82d allocates the options to cells of the table in a predetermined manner, thereby creating an option table. The option arranging unit 82d stores the option table in the option-display storage unit 72, and outputs a signal to the option-display control unit 82e to instruct it to display the option table. This process performed by the option arranging unit 82d will be described in detail later.

The option-display control unit 82e displays the options on the output unit 50 in a selectable manner. More specifically, upon receipt of a signal from the option arranging unit 82d, the option-display control unit 82e retrieves the option table from the option-display storage unit 72 and outputs the table to the output unit 50. The option-display control unit 82e also outputs a signal to the specific-option-display control unit 82f to instruct it to display a selection cursor.

The specific-option-display control unit 82f initially displays, on the output unit 50, the option arranged in the center cell such that the option is distinguishable from others as a likely option. More specifically, when receiving a signal from the option-display control unit 82e, the specific-option-display control unit 82f displays the option arranged in the center cell as the first likely option by, for example, placing the selection cursor on the option. When receiving a command to change the likely option through the input unit 40, the specific-option-display control unit 82f switches the likely option to another and displays it differently from others as the one currently designated as a likely option. When receiving a command to select the likely option through the input unit 40, the specific-option-display control unit 82f outputs the option currently designated as the likely option to the applications 81 as the result of selection.

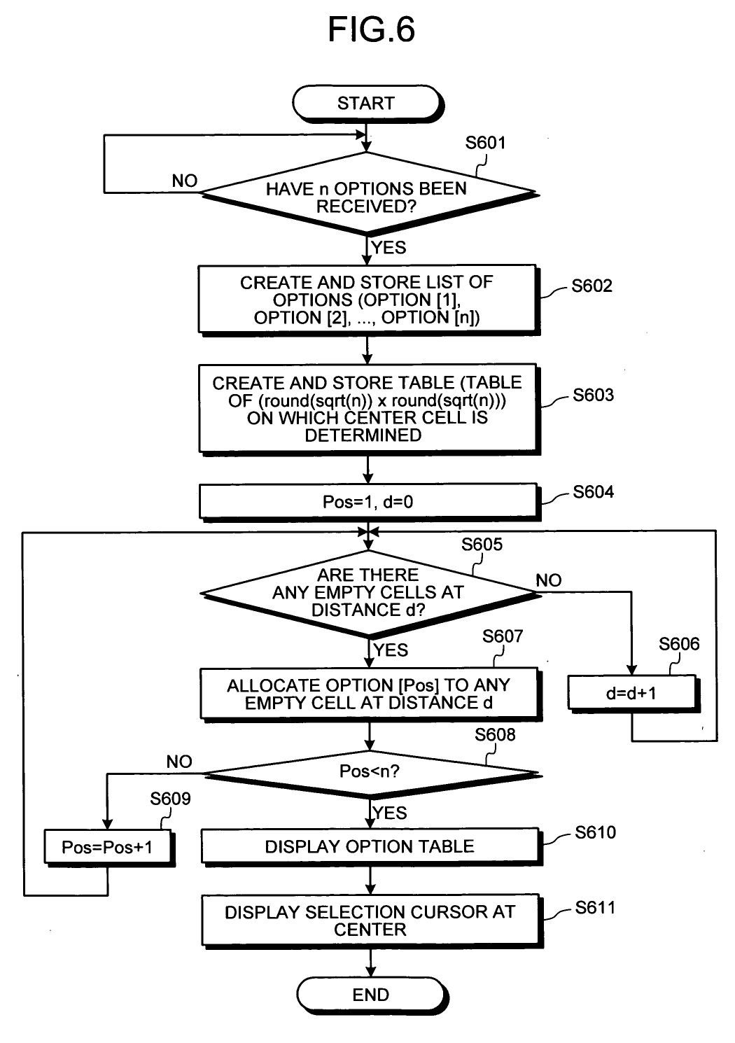

FIG. 6 is a flowchart of the operation of the display control unit 82. In the display control unit 82, when receiving n options (Yes at step S601), the option input unit 82a outputs the n options to the list creating unit 82b and outputs information on the number of the options to the table creating unit 82c.

Upon receipt of the n options from the option input unit 82a, the list creating unit 82b creates a list of the options (OPTION [1], OPTION [2], . . . , OPTION [n]) and stores the list in the option-display storage unit 72 (step S602). The OPTION [Pos] indicates an option with a [Pos] number (e.g., the OPTION [1] is the first option) in the list. Here, Pos (1=Pos=n) is a variable to be used in a process performed by the option arranging unit 82d.

When receiving the information on the number of the options from the option input unit 82a, the table creating unit 82c creates a table on which the position of a center cell is determined (table of round(sqrt(n))×round(sqrt(n))) and stores the table in the option-display storage unit 72 (step S603).

Next, the option arranging unit 82d substitutes default value 1 for the variable Pos, and default value 0 for another variable d (indicating a distance from the center cell, which can be reached by d times operations) (step S604).

The option arranging unit 82d retrieves from the option-display storage unit 72 the list created by the list creating unit 82b and the table created by the table creating unit 82c, and arranges the options sequentially on the table (steps S605 through S609). For simplicity and clarity of explanation, it is assumed herein that there are nine options (n=9).

FIG. 7 is a schematic for explaining the process of arranging the nine options on the table performed by the option arranging unit 82d. First, the option arranging unit 82d determines whether there is any empty cell at distance 0, i.e., the center cell, in the table (step S605). When there is an empty cell (Yes at step S605), the option arranging unit 82d allocates the OPTION [1] to the empty cell at distance 0 (step S607). At this point, as in table A of FIG. 7, the option arranging unit 82d allocates the OPTION [1] to the cell at distance 0 (shaded cell).

When the arrangement of all the n options is not completed (No at step S608), the option arranging unit 82d increments the variable Pos by 1 (step S609). The option arranging unit 82d again determines whether there is an empty cell at distance 0 (step S605).

At this point, the cell at distance 0 has already been occupied by the OPTION [1] and there is no empty cell at distance 0 (No at step S605). The option arranging unit 82d increments the variable d by 1 (step S606). Then, the option arranging unit 82d determines whether there is any empty cell at distance 1 (step S605). If any (Yes at step S605), the option arranging unit 82d arranges the OPTION [2] in the empty cell at distance 1 (step S607). At this point, as in table B of FIG. 7, the option arranging unit 82d allocates the OPTION [2] to one of cells at distance 1 (shaded cells).

When the arrangement of all the n options is not completed (No at step S608), the option arranging unit 82d increments the variable Pos to 3 (step S609). Then, the option arranging unit 82d again determines whether there is an empty cell at distance 1 (step S605).

At this point, there are three more empty cells at distance 1, and the option arranging unit 82d repeats the same process until all the cells at distance 1 are filled with options, i.e., until the variable Pos reaches 5.

When the variable Pos reaches 6, the OPTIONs [2] to [5] have been allocated to all the cells at distance 1, and the option arranging unit 82d determines that there is no more empty cell at distance 1 (No at step S605). The option arranging unit 82d increments the variable d to 2 (step S606) and determines whether there is any empty cell at distance 2 (step S605). If any (Yes at step S605), the OPTION [6] is arranged in the empty cell at distance 2 (step S607). At this point, as in table C of FIG. 7, the option arranging unit 82d allocates the OPTION [6] in one of cells at distance 2 (shaded cells).

When the arrangement of all the n options is not completed (No at step S608), the option arranging unit 82d increments the variable Pos to 7 (step S609). Then, the option arranging unit 82d again determines whether there is any more empty cell at distance 2 (step S605).

At this point, there are three more empty cells at distance 2, and the option arranging unit 82d repeats the same process until all the cells at distance 2 are filled with options, i.e., until the variable Pos reaches 9. As a result, the option arranging unit 82d completes the arrangement of all the nine options on the table as in table D of FIG. 7.

After the arrangement of all the n options is completed (Yes at step S608), the option arranging unit 82d stores the option table in the option-display storage unit 72, and outputs a signal to the option-display control unit 82e to instruct it to display the option table. The option-display control unit 82e retrieves the option table from the option-display storage unit 72 to output it to the output unit 50. Thus, the option table is displayed (step S610), in which the selection cursor is positioned on the center cell by the specific-option-display control unit 82f (step S611), and the process ends.

FIGS. 8 to 10 are examples of screen displays of the output unit 50. When the user executes, for example, a word-processing application on the information processing device 10 and inputs characters, the information processing device 10 displays text as shown in FIG. 8. When the user enters a kana-kanji conversion command for a kana word “koukou” and the display control unit 82 processes options generated by the word-processing application, the information processing device 10 displays an option table containing kanji options for the kana word “koukou” with the selection cursor placed on a kanji option in the center cell as shown in FIG. 9.

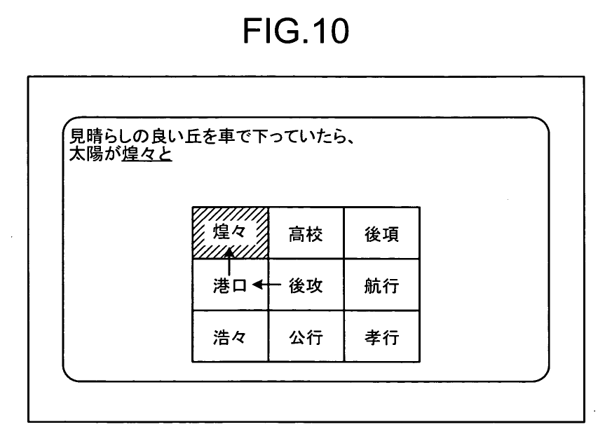

When, for example, the user provides input to move the selection cursor left by one cell and up by one cell, the selection cursor rests on a kanji option in the cell at the upper-left corner of the option table as shown in FIG. 10. Then, the information processing device 10 selects the option in response to user operation such as pressing the enter key, and completes the kana-kanji conversion process.

As described above, according to the first embodiment, multiple options are displayed in a selectable manner with a predetermined option arranged in a predetermined center and others arranged radially around the center option. The option arranged at the center is distinguishable from the others as a likely option. In other words, respective options are arranged at nearly the same distance from an option initially specified as a likely option, and fewer operations are required to change the likely option to another. Thus, user operation can be facilitated to select an option.

Moreover, the options are arranged based on predetermined criteria, and displayed on the display unit in a selectable manner. That is, the options are displayed orderly based on the criteria. Therefore, the user can easily find a target option.

In the first embodiment, options are sequentially allocated to empty cells from a predetermined center cell in order of increasing distance from the center cell. According to the second embodiment, options are arranged on the table based on a predetermined policy (hereinafter, “arrangement policy”).

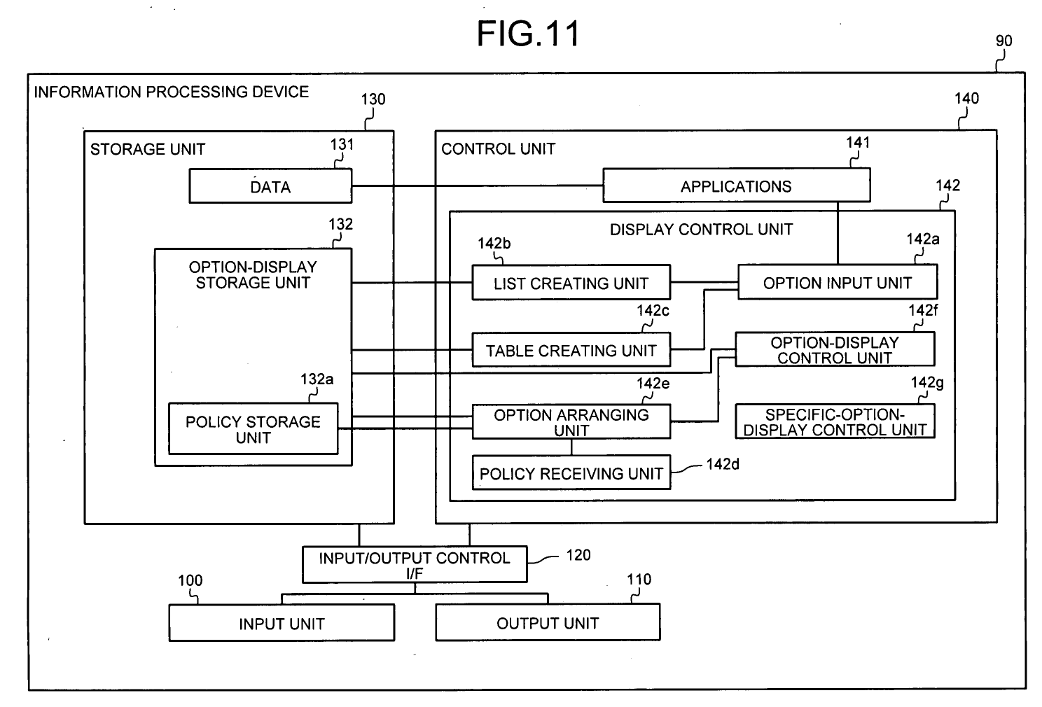

FIG. 11 is a block diagram of an information processing device 90 according to a second embodiment. The information processing device 90 includes an input unit 100, an output unit 110, an input/output control I/F 120, a storage unit 130, and a control unit 140.

The storage unit 130 stores therein various types of data 131, and includes an option-display storage unit 132. The option-display storage unit 132 includes a policy storage unit 132a. The control unit 140 is installed with various applications 141, and includes a display control unit 142. The display control unit 142 includes an option input unit 142a, a list creating unit 142b, a table creating unit 142c, a policy receiving unit 142d, an option arranging unit 142e, an option-display control unit 142f, and a specific-option-display control unit 142g. Incidentally, the information processing device 90 is in many respects basically similar to the information processing device 10, and operates in the same manner as described previously in the first embodiment, except for the policy storage unit 132a, the policy receiving unit 142d, and the option arranging unit 142e. Accordingly, the same description will not be repeated.

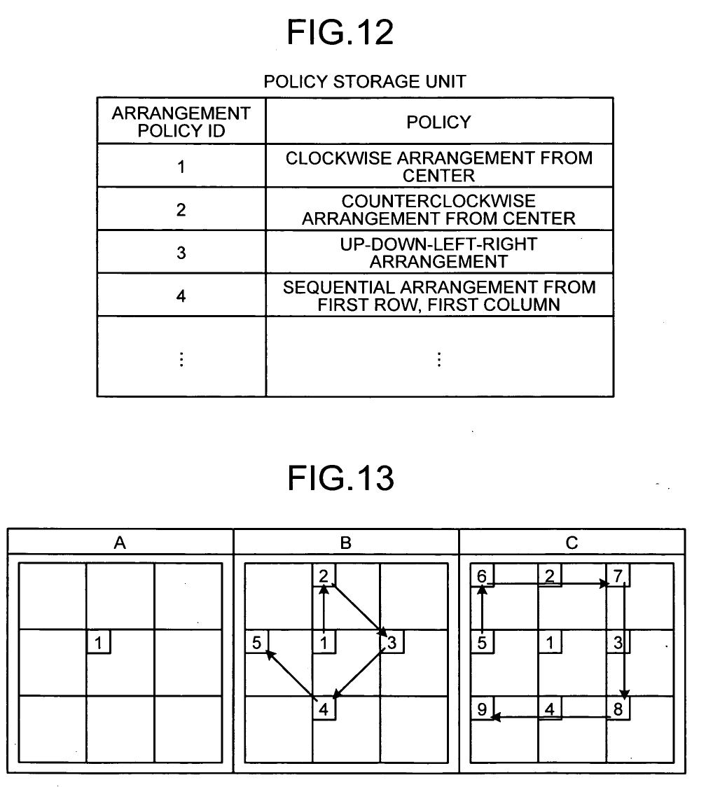

The policy storage unit 132a stores therein arrangement policies to display multiple options. More specifically, the policy storage unit 132a stores therein arrangement policies, i.e., specific rules based on which the option arranging unit 142e, explained later, allocates options on the table, in association with unique identification information. For example, the policy storage unit 132a stores, as shown in FIG. 12, an arrangement policy “clockwise arrangement from the center” associated with arrangement policy ID 1.

The policy receiving unit 142d receives information to be used when the option arranging unit 142e retrieves a specific arrangement policy from the policy storage unit 132a. More specifically, when receiving information relating to a change of arrangement policies (hereinafter, “change information”) through the input unit 100, the policy receiving unit 142d outputs the change information to the option arranging unit 142e. For example, upon receiving policy ID 1, the policy receiving unit 142d outputs policy ID 1 to the option arranging unit 142e.

The option arranging unit 142e arranges options based on an arrangement policy stored in the policy storage unit 132a. More specifically, the option arranging unit 142e retrieves from the option-display storage unit 132 a list created by the list creating unit 142b and a table created by the table creating unit 142c. The option arranging unit 142e also retrieves an arrangement policy from the policy storage unit 132a based on change information received from the policy receiving unit 142d. The option arranging unit 142e assigns the order of arrangement to each cell of the table based on the arrangement policy and allocates the options. Then, the option arranging unit 142e stores the option table thus obtained in the option-display storage unit 132, and outputs a signal to the option-display control unit 142f to instruct it to display the option table.

FIGS. 13 to 15 are schematics for explaining the process of assigning the order of arrangement to each cell of the table performed by the option arranging unit 142e. FIGS. 13 to 15 depict, for example, a 3×3 table where a cell in the second row and the second column is determined as the center cell. Other cells are represented based on the center cell. For example, a cell in the first row and the second column is referred to as upper cell. Cells in the first row and the third column and in the second row and the third column are referred to as upper-right cell and right cell, respectively.

For example, when receiving change information, policy ID 1, from the policy receiving unit 142d, the option arranging unit 142e retrieves the arrangement policy “clockwise arrangement from the center” that corresponds to policy ID 1 (see FIG. 12) from the policy storage unit 132a, and assigns order 1, indicating that an option is allocated first to the center cell, to the center cell. At this point, the order of arrangement is assigned to the table as in table A of FIG. 13.

Next, the option arranging unit 142e assigns the order to other cells in a clockwise direction based on the arrangement policy, i.e., order 2 to the upper cell, order 3 to the right cell, order 4 to the lower cell, and order 5 to the left cell. At this point, the order of arrangement is assigned to the table as in table B of FIG. 13.

Then, the option arranging unit 142e assigns order 6 to the upper-left cell, order 7 to the upper-right cell, order 8 to the lower-right cell, and order 9 to the lower-left cell in a clockwise direction based on the arrangement policy. At this point, the order of arrangement is assigned to the table as in table C of FIG. 13.

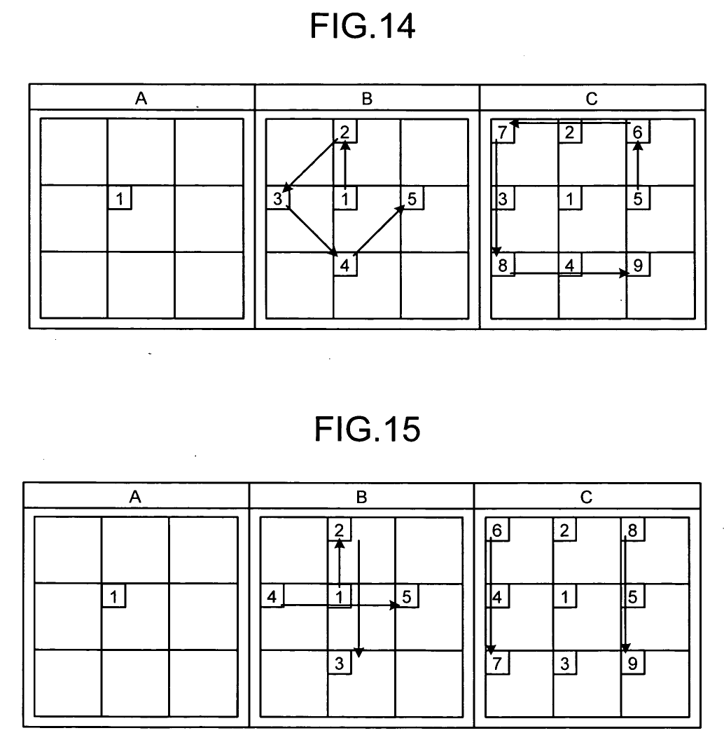

When receiving change information, policy ID 2, from the policy receiving unit 142d, the option arranging unit 142e retrieves from the policy storage unit 132a the arrangement policy “counterclockwise arrangement from the center” corresponding to policy ID 2, (see FIG. 12). The option arranging unit 142e assigns order 1 to the center cell. At this point, the order of arrangement is assigned to the table as in table A of FIG. 14.

Next, the option arranging unit 142e assigns order 2 to the upper cell, order 3 to the left cell, order 4 to the lower cell, and order 5 to the right cell in a counterclockwise direction based on the arrangement policy. At this point, the order of arrangement is assigned to the table as in table B of FIG. 14.

Then, the option arranging unit 142e assigns order 6 to the upper-right cell, order 7 to the upper-left cell, order 8 to the lower-left cell, and order 9 to the lower-right cell in a counterclockwise direction based on the arrangement policy. At this point, the order of arrangement is assigned to the table as in table C of FIG. 14.

When receiving change information, policy ID 3, from the policy receiving unit 142d, the option arranging unit 142e retrieves from the policy storage unit 132a the arrangement policy, “up-down-left-right arrangement from the center” corresponding to policy ID 3 (see FIG. 12). The option arranging unit 142e assigns order 1 to the center cell. At this point, the order of arrangement is assigned to the table as in table A of FIG. 15.

Next, the option arranging unit 142e assigns order 2 to the upper cell, order 3 to the lower cell, order 4 to the left cell, and order 5 to the right cell in the order of up, down, left and right based on the arrangement policy. At this point, the order of arrangement is assigned to the table as in table B of FIG. 15.

Then, the option arranging unit 142e assigns order 6 to the upper-left cell, order 7 to the lower-left cell, order 8 to the upper-right cell, and order 9 to the lower-right cell in the order of up, down, left and right based on the arrangement policy. At this point, the order of arrangement is assigned to the table as in table C of FIG. 15.

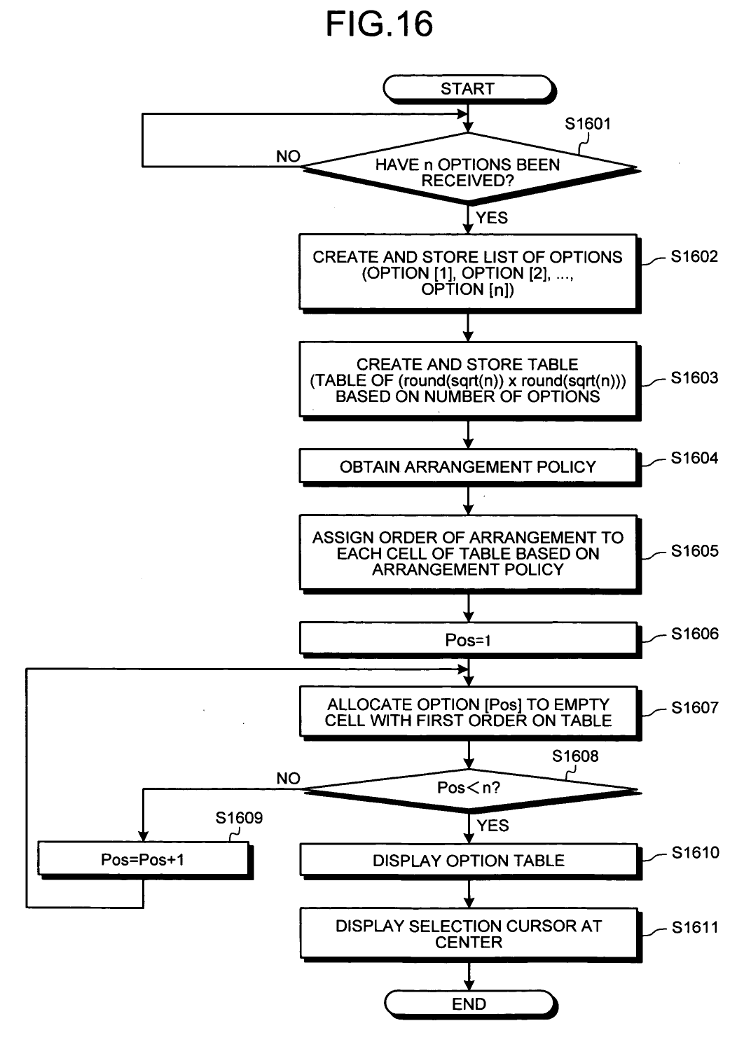

FIG. 16 is a flowchart of the operation of the display control unit 142. In the display control unit 142, when receiving n options (Yes at step S1601), the option input unit 142a outputs the n options to the list creating unit 142b and information on the number of the options to the table creating unit 142c.

Upon receiving the n options from the option input unit 142a, the list creating unit 142b creates a list of the options (OPTION [1], OPTION [2], . . . , OPTION [n]) and stores the list in the option-display storage unit 132 (step S1602). The OPTION [Pos] indicates an option with a [Pos] number in the list. Here, Pos (1=Pos=n) is a variable to be used in the process performed by the option arranging unit 142e.

When receiving the information on the number of the options from the option input unit 142a, the table creating unit 142c creates a table on which the position of a center cell is determined (table of round(sqrt(n))×round(sqrt(n))) and stores the table in the option-display storage unit 132 (step S1603).

Next, the option arranging unit 142e obtains an arrangement policy from the policy storage unit 132a (step S1604) and retrieves the table from the option-display storage unit 132. Then, the option arranging unit 142e assigns the order of arrangement to each cell of the table based on the arrangement policy (step S1605). After that, the option arranging unit 142e substitutes default value 1 for the variable Pos (step S1606).

The option arranging unit 142e sequentially arranges the options on the table, to which the order of arrangement has been assigned, using the list retrieved from the option-display storage unit 132 (steps S1607 to S1609). For simplicity and clarity of explanation, it is assumed herein that there are nine options (n=9), and the order of arrangement has been assigned based on the arrangement policy “clockwise arrangement from the center”.

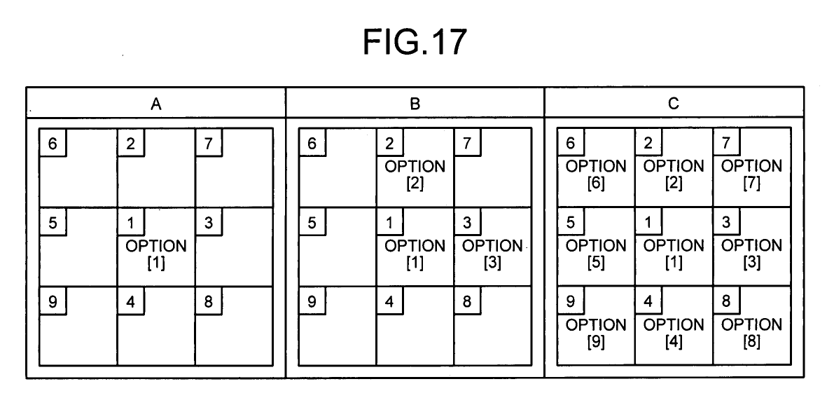

FIG. 17 is a schematic for explaining the process of arranging nine options on the table performed by the option arranging unit 142e. First, the option arranging unit 142e arranges the OPTION [1] in an empty cell with the first order on the table (step S1607). At this point, the OPTION [1] is allocated by the option arranging unit 142e to the cell assigned order 1 as in table A of FIG. 17.

When the arrangement of all the n options is not completed (No at step S1608), the option arranging unit 142e increments the variable Pos by 1 (step S1609). The option arranging unit 142e allocates the OPTION [2] to an empty cell assigned order 2 (step S1607). After this process is repeated until the variable Pos reaches 3, the OPTIONs [1], [2], and [3] are allocated by the option arranging unit 142e to the cells assigned order 1, 2, and 3, respectively, as in table B of FIG. 17.

The option arranging unit 142e repeats the same process until the variable Pos reaches 9, and allocates the OPTION [9] to an empty cell assigned order 9 (step S1607). As a result, the option arranging unit 142e completes the arrangement of all the nine options on the table as in table C of FIG. 17.

After the arrangement of all the n options is completed (Yes at step S1608), the option arranging unit 142e stores the option table in the option-display storage unit 132, and outputs a signal to the option-display control unit 142f to instruct it to display the option table. The option-display control unit 142f retrieves the option table from the option-display storage unit 132 to output it to the output unit 110. Thus, the option table is displayed (step S1610), in which the selection cursor is positioned on the center cell by the specific-option-display control unit 142g (step S1611), and the process ends.

As described above, according to the second embodiment, options are arranged based on an arrangement policy, and displayed on the display unit in a selectable manner. That is, the options are displayed orderly based on the arrangement policy. Therefore, the user can easily find a target option.

In the second embodiment, the arrangement of options is performed without priority. According to a third embodiment, priority is assigned to generated options. Incidentally, the information processing device of the third embodiment is essentially similar to the information processing device 90 shown in FIG. 11, and operates in a similar manner except for the applications 141, the option input unit 142a, and the list creating unit 142b. Accordingly, the same description will not be repeated.

The applications 141 are application software executed for different jobs and different purposes. If multiple options are generated when executed, the application 141 assigns priorities to the options and outputs them to the option input unit 142a. More specifically, when word-processing software is executed and multiple options are generated as a result of kana-kanji conversion, the application 141 assigns priorities to the options based on, for example, their frequencies of use, and outputs them to the option input unit 142a.

The option input unit 142a receives the options generated and assigned priorities by the application 141. More specifically, upon receiving the options assigned priorities from word-processing software or the like, the option input unit 142a outputs them to the list creating unit 142b together with priority information based on the priorities. The option input unit 142a also outputs the information on the number of the options to the table creating unit 142c.

For example, having received nine kanji options for a kana word “koukou” from word-processing software, the option input unit 142a outputs the kanji options together with priority information, such as 1, 2, and 3, to the list creating unit 142b. The option input unit 142a also outputs the information on the number of the options: 9 to the table creating unit 142c.

The list creating unit 142b receives from the option input unit 142a the options with the priority information, and creates a list of the options. The list is stored in the option-display storage unit 132. More specifically, when receiving the options with the priority information from the option input unit 142a, the list creating unit 142b sorts the options based on the priority information, and creates a list in which the options are associated with identification information (information to be processed by the option arranging unit 142e, preferably serial numbers starting with 1). The list is stored in the option-display storage unit 132.

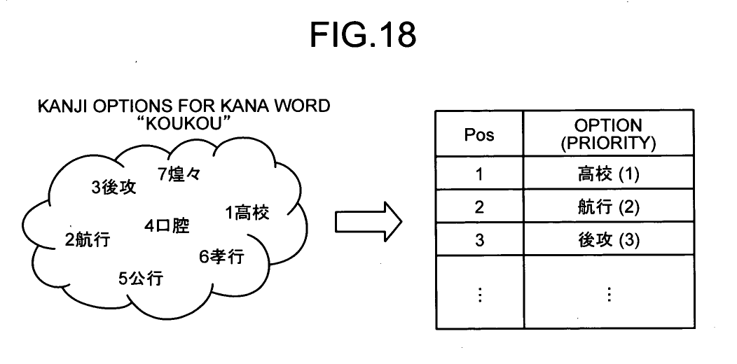

FIG. 18 is a schematic for explaining the process of creating a list performed by the list creating unit 142b. For example, the list creating unit 142b sorts kanji options for a kana word “koukou”, which have been assigned priorities 1 to 7, based on the priority information as shown in FIG. 18. The list creating unit 142b creates a list of the options in which each kanji option is associated with a number, etc. indicating the priority thereof. The list is stored in the option-display storage unit 132.

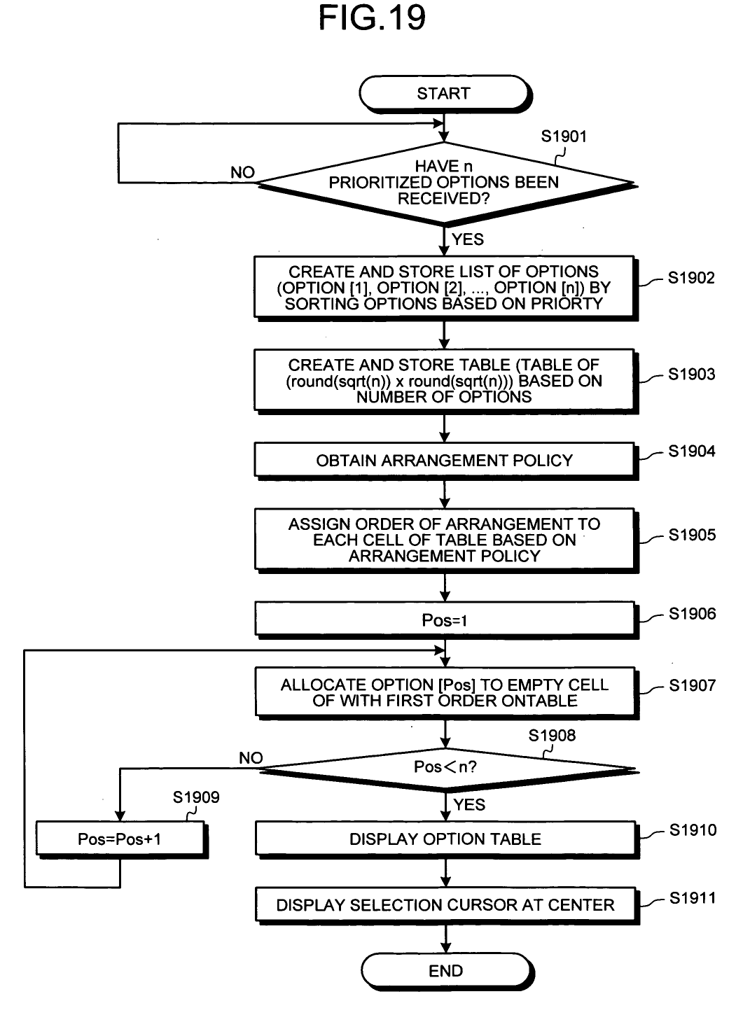

FIG. 19 is a flowchart of the operation of the display control unit 142 according to the third embodiment. In the third embodiment, the display control unit 142 operates in basically the same manner as in the second embodiment, except for that the list creating unit 142b sorts options based on priority. Thus, the explanation will be brief.

In the display control unit 142, when receiving n options assigned priorities (Yes at step S1901), the option input unit 142a outputs the n options together with priority information to the list creating unit 142b. The option input unit 142a also outputs information on the number of the options to the table creating unit 142c.

Upon receipt of the n options assigned priorities from the option input unit 142a, the list creating unit 142b creates a list of the options (OPTION [Pos]=OPTION [1], OPTION [2], . . . , OPTION [n]) while sorting the options based on the priority information, and stores the list in the option-display storage unit 132 (step S1902). Here, Pos (1=Pos=n) is a variable to be used in the process performed by the option arranging unit 142e. The OPTION [Pos] indicates an option with a [Pos] number in the list.

When receiving the information on the number of the options from the option input unit 142a, the table creating unit 142c creates a table on which the position of a center cell is determined (table of round(sqrt(n))×round(sqrt(n))) and stores the table in the option-display storage unit 132 (step S1903). The option arranging unit 142e obtains an arrangement policy from the policy storage unit 132a (step S1904), and assigns the order of arrangement to each cell of the table retrieved from the option-display storage unit 132 based on the arrangement policy (step S1905). After that, the option arranging unit 142e substitutes default value 1 for the variable Pos (step S1906).

Thereafter, the option arranging unit 142e sequentially arranges the options on the table to which the order of arrangement has been assigned using the list retrieved from the option-display storage unit 132 (steps S1907 to S1909). After arranging all the n options (Yes at step S1908), the option arranging unit 142e outputs a signal to the option-display control unit 142f to instruct it to display the option table.

The option-display control unit 142f retrieves the option table from the option-display storage unit 132 to output it to the output unit 110. Thus, the option table is displayed (step S1910), in which the selection cursor is positioned on the center cell by the specific-option-display control unit 142g (step S1911), and the process ends.

As described above, according to the third embodiment, multiple options are assigned priorities, as attributes, which indicates the level of the possibility of being selected. The options are displayed in a selectable manner with an option having the highest priority arranged in a predetermined center cell and the rest arranged radially around the center option. Thus, the option with the highest priority is arranged at the center and is distinguishable from the others as a likely option. That is, the option with the highest priority is displayed as the first likely option, which helps the user more easily find a target option.

In a fourth embodiment, the information processing device 90 of the third embodiment is applied to a vehicle navigation system. In the following explanation, it is assumed that, as a result of search for a station nearby a certain place or point, nine options are generated with priorities as follows: 1. Musashi Nakahara Station, 2. Musashi Shinjo Station, 3. Musashi Kosugi Station, 4. Motosumiyoshi Station, 5. Mukaigawara Station, 6. Hirama Station, 7. Musashi Mizonokuchi Station, 8. Tamagawa Station, and 9. Tsudayama Station.

The option input unit 142a of the display control unit 142 receives the nine prioritized options resulting from the search on the application 141. Then, the option input unit 142a outputs the options together with priority information to the list creating unit 142b. The option input unit 142a also outputs information on the number of the options: 9 to the table creating unit 142c.

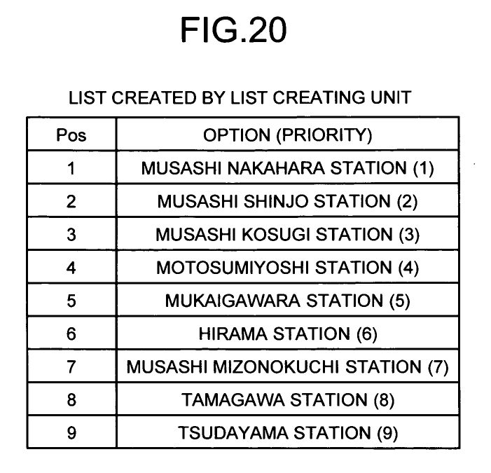

FIG. 20 depicts contents of a list created by the list creating unit 142b in this case. The list creating unit 142b sorts the nine options based on the priority information, and creates a list in which each option is associated with one of serial numbers 1 to 9 in descending order of priority as shown in FIG. 20.

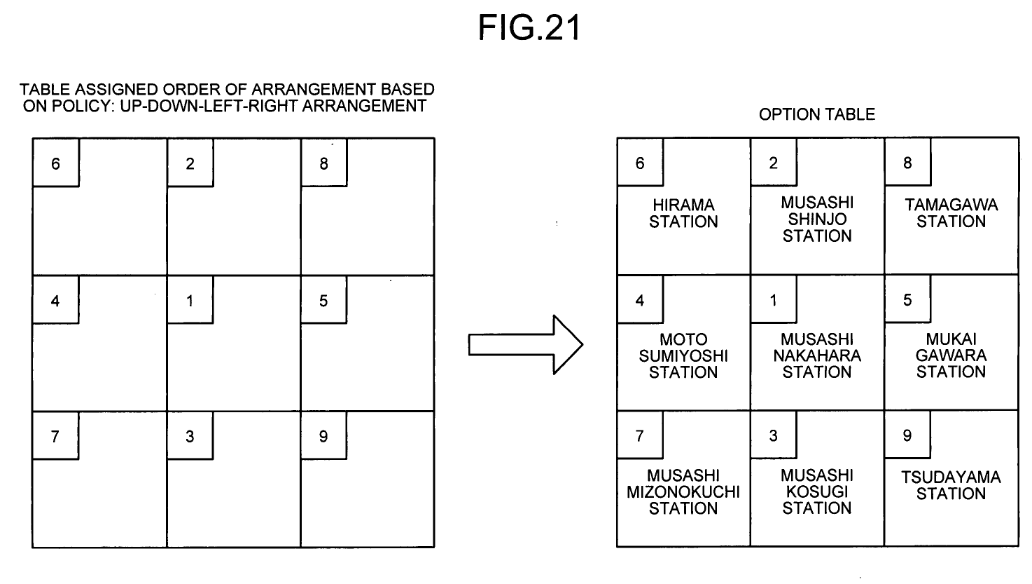

FIG. 21 depicts a table created by the table creating unit 142c in this case. The option arranging unit 142e assigns the order of arrangement according to the arrangement policy “up-down-left-right arrangement” to a table based on the information on the number of the options: 9. The option arranging unit 142e then allocates the options based on the aforementioned list as shown in FIG. 21.

The option-display control unit 142f retrieves the option table from the option-display storage unit 132 and outputs it to the output unit 110. Thus, the option table is displayed in which the selection cursor is positioned by the specific-option-display control unit 142g on an option arranged in the center cell as the first likely option.

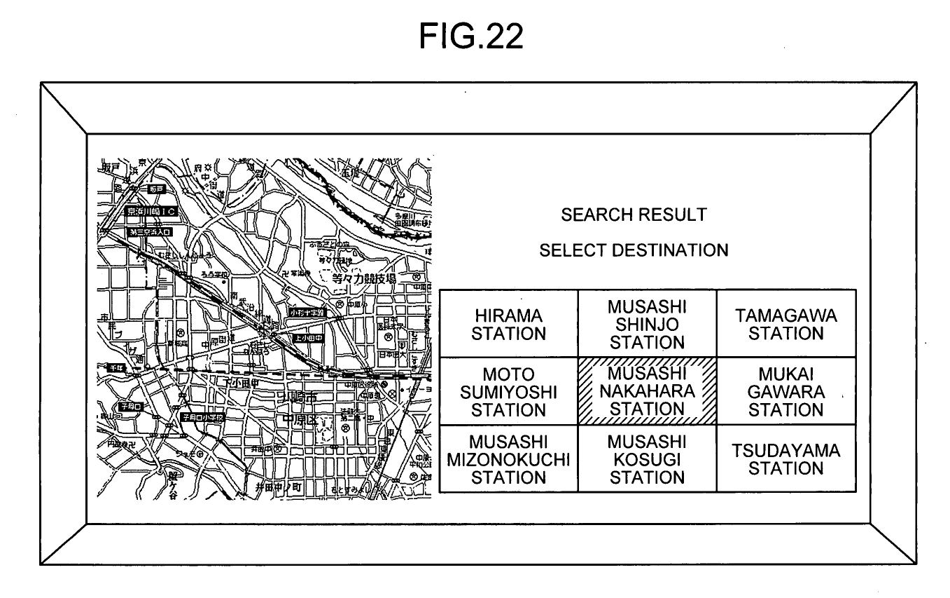

FIG. 22 depicts a screen display of the output unit 110 in this case. As shown in FIG. 22, the option table is displayed on the screen of the output unit 110 with the selection cursor on the option “Musashi Nakahara Station” in the center cell.

As described above, when the information processing device is applied to the vehicle navigation system, the option with the highest priority is displayed as the first likely option. Thus, the user can quickly find the target option.

In the fourth embodiment, the information processing device 90 is applied to a vehicle navigation system where generated options are assigned priorities. According to a fifth embodiment, similarly to the fourth embodiment, the information processing device 90 is applied to a vehicle navigation system where generated options have attributes (positional information such as north, south, east, and west). Incidentally, the information processing device (vehicle navigation system) of the fifth embodiment is essentially similar to the information processing device 90 shown in FIG. 11, and operates basically in a similar manner. Accordingly, the same description will not be repeated.

The applications 141 are application software to implement various functions of the vehicle navigation system. If multiple options are generated when executed, the application 141 adds attributes to the options and outputs them to the option input unit 142a. More specifically, the application 141 searches for a place such as a station and a restaurant nearby a certain place or point. When several options are found, the application 141 adds attributes (positional information such as north, south, east, and west) to the options. The attributes are established based on the positional relation to an option corresponding to the closest place as the center. The resultant options are output to the option input unit 142a.

The option input unit 142a receives the options with attributes from the application 141. More specifically, when receiving the options each having an attribute from the application 141, the option input unit 142a outputs the options together with attribute information to the list creating unit 142b. The option input unit 142a also outputs information on the number of the options to the table creating unit 142c. For example, when receiving from the application 141 nine station options including Musashi Nakahara Station having an attribute “center”, Musashi Shinjo Station “north”, and Motosumiyoshi Station “west” as a result of search for a station near a certain place or point, the option input unit 142a outputs the options together with attribute information, such as center, north, and west, to the list creating unit 142b and information on the number of the options: 9 to the table creating unit 142c.

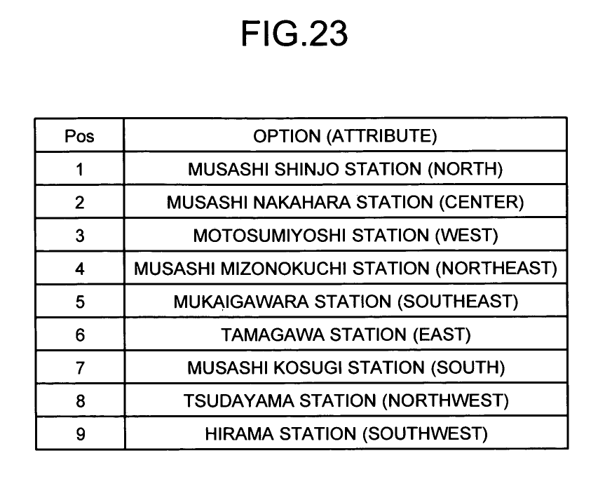

The list creating unit 142b receives the options together with the attribute information from the option input unit 142a, creates a list of the options, and stores the list in the option-display storage unit 132. More specifically, upon receipt of the options with the attribute information from the option input unit 142a, the list creating unit 142b creates a list in which the options are associated with identification information (information to be processed by the option arranging unit 142e, preferably serial numbers starting with 1). The list is stored in the option-display storage unit 132. FIG. 23 is an example of the list created by the list creating unit 142b in this case. As shown in FIG. 23, the option “Musashi Shinjo Station (north)” is associated with identification information 1, “Musashi Nakahara Station (center)” with 2, and “Motosumiyoshi Station (west)” with 3.

The option arranging unit 142e displays on the output unit 110 the options arranged based on an arrangement policy stored in the policy storage unit 132a in a selectable manner. More specifically, the option arranging unit 142e retrieves the list created by the list creating unit 142b and the table created by the table creating unit 142c from the option-display storage unit 132. The option arranging unit 142e also retrieves an arrangement policy from the policy storage unit 132a in response to change information received through the policy receiving unit 142d. The option arranging unit 142e assigns an attribute to each cell of the table based on the arrangement policy and allocates the options. The option table thus obtained is stored in the option-display storage unit 132. Then, the option arranging unit 142e outputs a signal to the option-display control unit 142f to instruct it to display the option table.

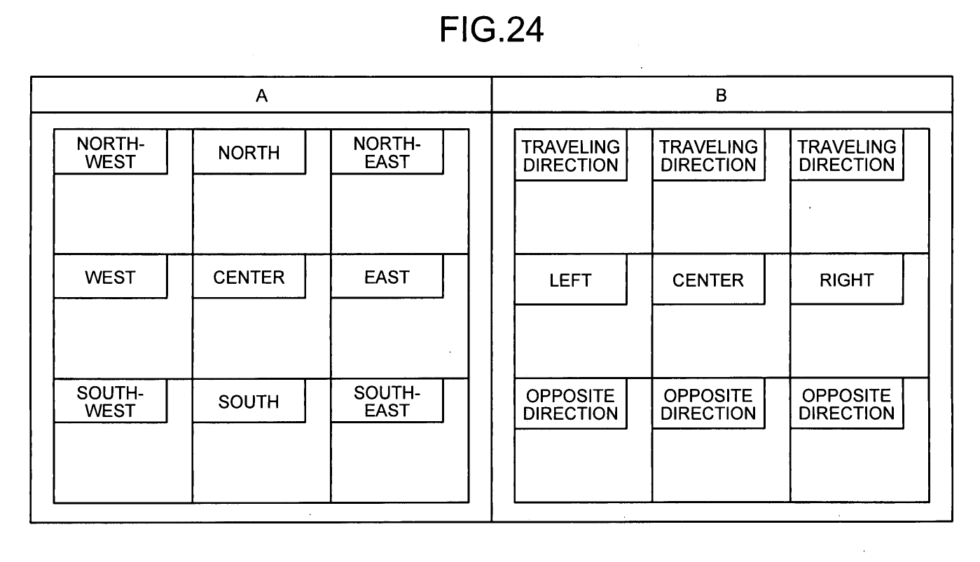

FIG. 24 is examples of tables to which the option arranging unit 142e assigns attributes. For example, the option arranging unit 142e assigns attributes to the cells of a 3×3 table based on the arrangement policy “directional-relation-based arrangement (south, north, west, east, etc.)” as in table A of FIG. 24. Similarly, the option arranging unit 142e can assign attributes to the cells based on the arrangement policy “positional-relation-based arrangement (forward, backward, left, right, etc.)” as in table B of FIG. 24.

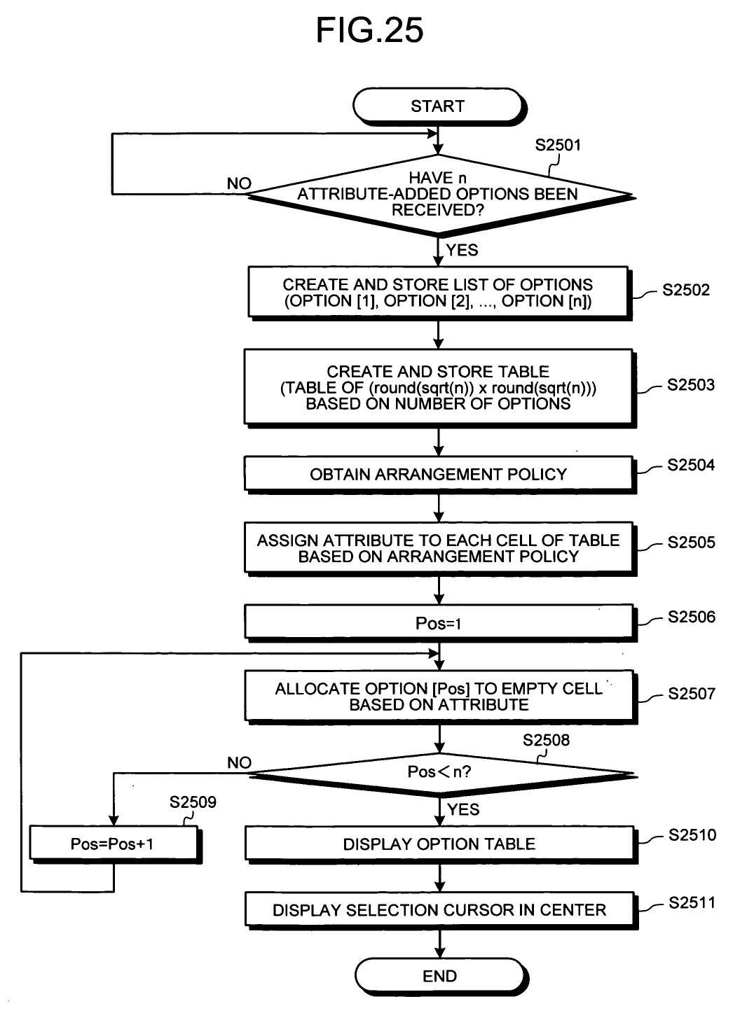

FIG. 25 is a flowchart of the operation of the display control unit 142 of the vehicle navigation system according to the fifth embodiment. First, the option input unit 142a receives n options having attributes (Yes at step S2501). Then, the option input unit 142a outputs the n options together with attribute information to the list creating unit 142b and the information on the number of the options to the table creating unit 142c.

Upon receiving the n options with the attribute information from the option input unit 142a, the list creating unit 142b creates a list of the options (OPTION [Pos]=OPTION [1], OPTION [2], . . . , OPTION [n]) and stores the list in the option-display storage unit 132 (step S2502). Here, Pos(1=Pos=n) is a variable to be used in the process performed by the option arranging unit 142e. The OPTION [Pos] indicates an option with a [Pos] number in the list.

When receiving the information on the number of the options from the option input unit 142a, the table creating unit 142c creates a table (table of round(sqrt(n))×round(sqrt(n))) and stores the table in the option-display storage unit 132 (step S2503). The option arranging unit 142e obtains an arrangement policy from the policy storage unit 132a (step S2504). Then, the option arranging unit 142e assigns an attribute to each cell of the table retrieved from the option-display storage unit 132 based on the arrangement policy (step S2505), and substitute default value 1 for the variable Pos (step S2506).

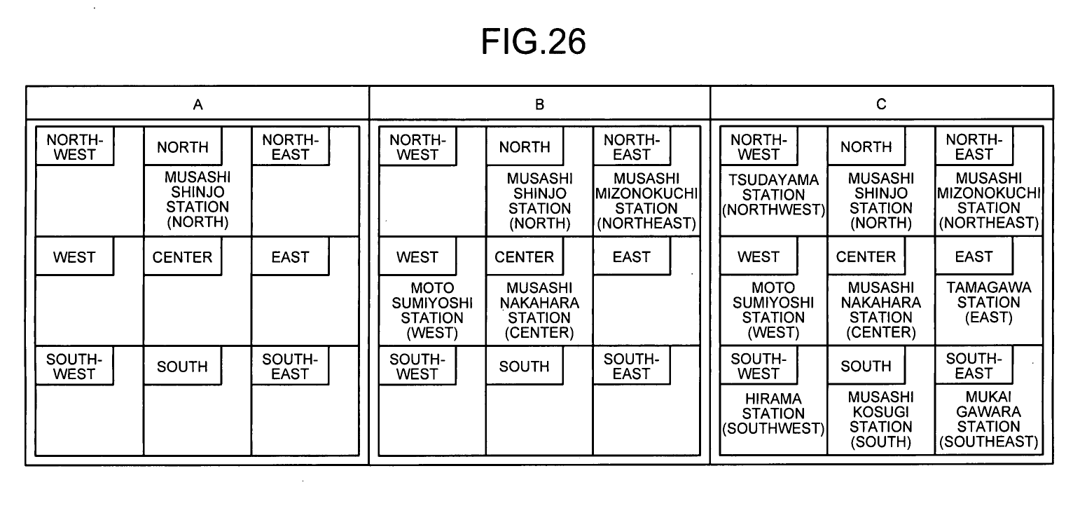

FIG. 26 illustrates the process of arranging the options on the table performed by the option arranging unit 142e. The option arranging unit 142e allocates the options onto the table, to which attributes have been assigned, using the list retrieved from the option-display storage unit 132 as in tables A to C of FIG. 26 (steps S2507 to S2509). When the arrangement of all the n options is completed (Yes at step S2508), the option table is stored in the option-display storage unit 132. Subsequently, the option arranging unit 142e outputs a signal to the option-display control unit 142f to instruct it to display the option table.

The option-display control unit 142f retrieves the option table from the option-display storage unit 132 to output it to the output unit 110. Thus, the option table is displayed (step S2510), in which the selection cursor is positioned on the center cell by the specific-option-display control unit 142g (step S2511), and the process ends.

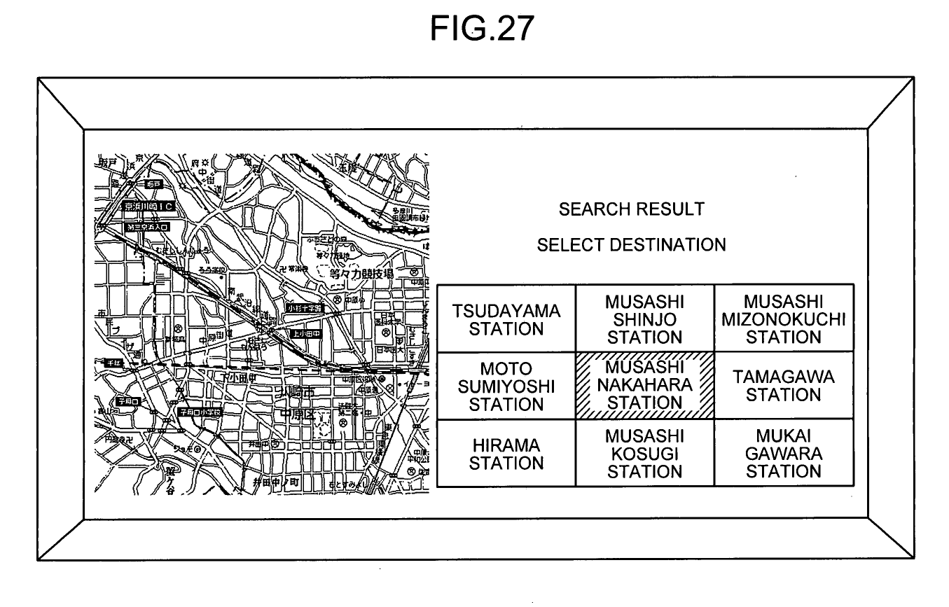

FIG. 27 is an example of a screen display of the output unit 110. As shown in FIG. 27, the option table is displayed on the screen of the output unit 110 with the selection cursor on an option in the center cell, i.e., “Musashi Nakahara Station”. Differently from the fourth embodiment, the arrangement of the options reflects the actual locations of the options with respect to an option in the center cell.

As described above, according to the fifth embodiment, options are assigned, as attributes, positional information indicating the positions of the options. The options are displayed in a selectable manner such that an option corresponding to a place closest to the current location is arranged at the center, while the rest are arranged radially around the center option based on the positional information. Thus, the option corresponding to a place closest to the current location is arranged at the center and is distinguishable as the first likely option from the others arranged correspondingly to directions from the current location. This helps the user quickly find a desired option, and enables the user to intuitively understand the positions of the options. In the above explanation, the size of the table is automatically determined based on the number of received options. However, if the number of options has been determined, the size of the table, with an arrangement policy, can be specified by the user.

In the first through fifth embodiments, options are arranged on a single table and the table is displayed on the display unit. According to a sixth embodiment, options are sorted by attributes, and a plurality of tables is created with respect to each attribute to allocate the options, so that the tables are displayed on the display unit.

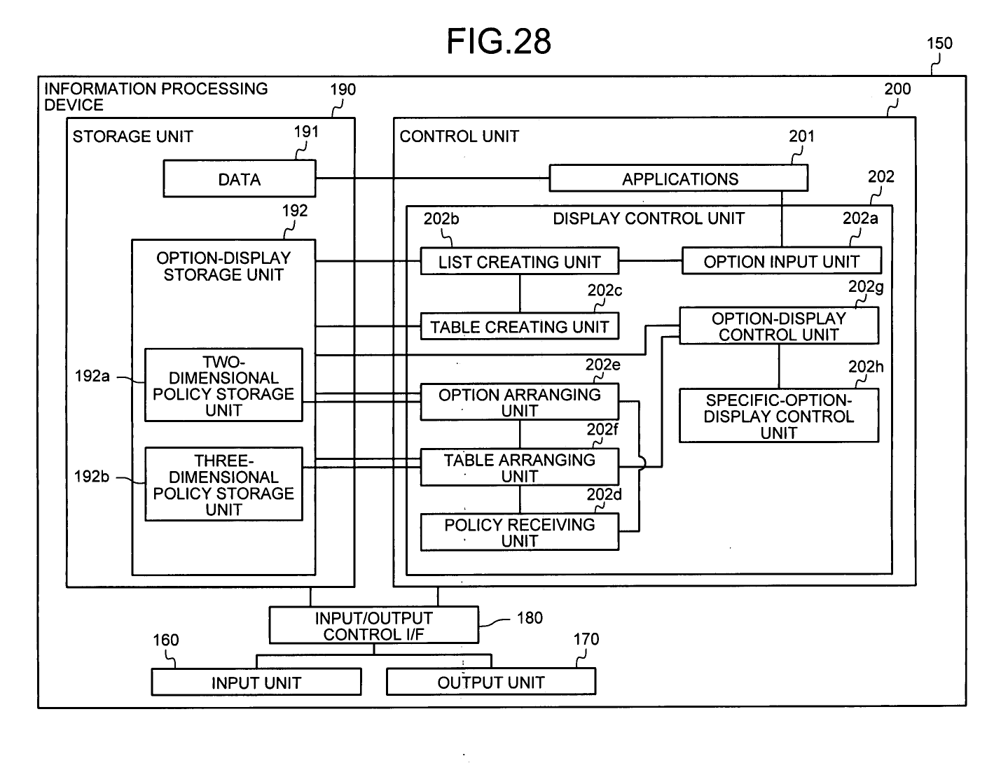

FIG. 28 is a block diagram of an information processing device 150 according to the sixth embodiment. The information processing device 150 includes an input unit 160, an output unit 170, an input/output control I/F 180, a storage unit 190, and a control unit 200.

The storage unit 190 stores therein various types of data 191, and includes an option-display storage unit 192. The option-display storage unit 192 includes a two-dimensional policy storage unit 192a and a three-dimensional policy storage unit 192b. The control unit 200 is installed with various applications 201, and includes a display control unit 202. The display control unit 202 includes an option input unit 202a, a list creating unit 202b, a table creating unit 202c, a policy receiving unit 202d, an option arranging unit 202e, a table arranging unit 202f, an option-display control unit 202g, and a specific-option-display control unit 202h. Incidentally, the information processing device 150 is in many respects basically similar to those described in the first to fifth embodiments and operates in a similar manner, and accordingly, the same description will not be repeated. In the following, the two-dimensional policy storage unit 192a, the three-dimensional policy storage unit 192b, the option input unit 202a, the list creating unit 202b, the table creating unit 202c, the policy receiving unit 202d, the option arranging unit 202e, the table arranging unit 202f, the option-display control unit 202g, and the specific-option-display control unit 202h will be discussed.

The two-dimensional policy storage unit 192a stores therein arrangement policies to display multiple options, as with the policy storage unit 132a. More specifically, the two-dimensional policy storage unit 192a stores therein two-dimensional arrangement policies, i.e., specific rules based on which the option arranging unit 202e, described later, arranges options on the tables, in association with unique identification information.

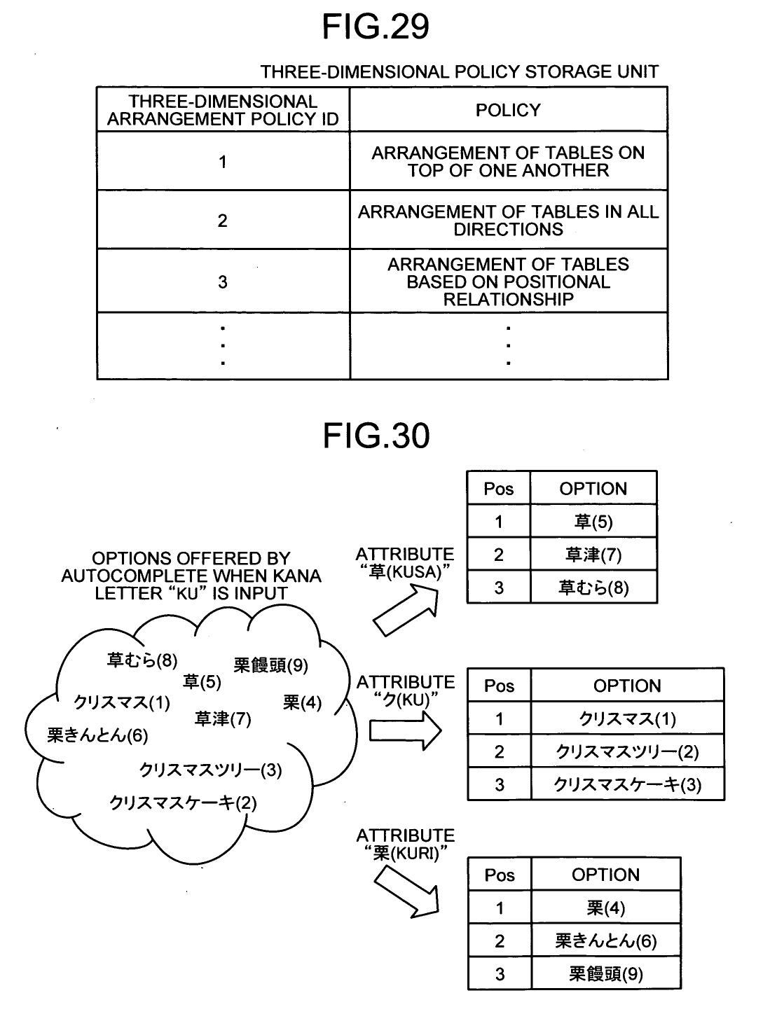

The three-dimensional policy storage unit 192b stores therein arrangement policies to display tables in a browsable manner. More specifically, the three-dimensional policy storage unit 192b stores therein three-dimensional arrangement policies, i.e., specific rules based on which the table arranging unit 202f, described later, arranges tables, in association with unique identification information. For example, the three-dimensional policy storage unit 192b stores, as shown in FIG. 29, an arrangement policy “arrangement of tables on top of one another” associated with policy ID 1.

The option input unit 202a receives options assigned priorities from the applications 201. More specifically, the option input unit 142a operates basically in a similar manner to that of the third embodiment, except for the process of outputting information on the number of the options to the list creating unit 202b. In other words, the option input unit 142a receives the prioritized options from word-processing software or the like, and outputs the options together with priority information to the list creating unit 202b.

The list creating unit 202b creates lists of the options received from the option input unit 202a, and stores the lists in the option-display storage unit 192. More specifically, the list creating unit 202b receives the options together with the priority information from the option input unit 202a, and sorts the options into different attributes based on specific rules (such as word classes and the initial letter of option words). The list creating unit 202b also sorts the options based on the priority information within each attribute group, and creates a list for each attribute in which the respective options are associated with identification information (information to be processed by the option arranging unit 202e, preferably serial numbers starting with 1). Then, the list creating unit 202b stores the lists with attribute information in the option-display storage unit 192. The list creating unit 202b outputs information on the total number of the options in the lists together with the attribute information to the table creating unit 202c, described later.

FIG. 30 illustrates the process of creating the lists performed by the list creating unit 202b. For example, when nine options assigned with priorities 1 to 9, respectively, are generated for a kana letter “ku” by the autocomplete function as shown in FIG. 30. The list creating unit 202b sorts these options into three attributes by their initial letters or characters: a kanji character “kusa”, a katakana letter “ku”, and a kanji character “kuri”. The list creating unit 202b also sorts the options for each attribute based on the priority information to create lists. In other words, with respect to each attribute, the list creating unit 202b associates the options with identification information (1 to 3) in descending order of priority to create the lists of the options.

The table creating unit 202c creates tables for different attributes based on the information received from the list creating unit 202b, and stores the tables in the option-display storage unit 192. More specifically, when receiving the information on the number of the options together with the attribute information from the list creating unit 202b, the table creating unit 202c creates a table for each attribute, in which cells are arranged in a matrix based on the information. Then, the table creating unit 202c determines the center cell to be used in the process performed by the option arranging unit 202e. The table creating unit 202c also stores the tables with the attribute information in the option-display storage unit 192.

The policy receiving unit 202d receives information to be used when the option arranging unit 202e and the table arranging unit 202f retrieve a specific arrangement policy from the two-dimensional policy storage unit 192a and the three-dimensional policy storage unit 192b, respectively. More specifically, when receiving change information that indicates a change in the two-dimensional arrangement policy through the input unit 160, the policy receiving unit 202d outputs the change information to the option arranging unit 202e. When receiving change information that indicates a change in the three-dimensional arrangement policy, the policy receiving unit 202d outputs the change information to the table arranging unit 202f.

The option arranging unit 202e allocates the options based on an arrangement policy stored in the two-dimensional policy arranging unit 192a. More specifically, the option arranging unit 202e retrieves a list created by the list creating unit 202b and a table created by the table creating unit 202c, from the option-display storage unit 192, for the same attribute. The option arranging unit 202e also obtains a two-dimensional arrangement policy from the two-dimensional policy storage unit 192a according to the change information received from the policy receiving unit 202d. The option arranging unit 202e assigns the order of arrangement to each cell of the table based on the two-dimensional arrangement policy and allocates the options. Then, the option arranging unit 202e stores all option tables thus obtained in the option-display storage unit 192. Subsequently, the option arranging unit 202e sends a signal to the table arranging unit 202f to instruct it to arrange the option tables.

The table arranging unit 202f arranges the option tables based on an arrangement policy stored in the three-dimensional policy storage unit 192b. More specifically, upon receipt of a signal from the option arranging unit 202e, the table arranging unit 202f retrieves the option tables from the option-display storage unit 192. The table arranging unit 202f also obtains a three-dimensional arrangement policy from the three-dimensional policy storage unit 192b according to the change information received from the policy receiving unit 202d, and arranges the option tables based on the three-dimensional arrangement policy. The arranged option tables are stored in the option-display storage unit 192. Then, the table arranging unit 202f outputs a signal to the option-display control unit 202g to instruct it to display the arranged option tables.

The option-display control unit 202g displays the arranged option tables on the output unit 170. More specifically, upon receipt of the signal from the table arranging unit 202f, the option-display control unit 202g retrieves the arranged option tables from the option-display storage unit 192 and outputs the option tables to the output unit 170. The option-display control unit 202g also outputs a signal to the specific-option-display control unit 202h to instruct it to display the selection cursor.

The specific-option-display control unit 202h displays an option that is positioned in the center of a specific area among a plurality of areas such that the option is distinguishable as a likely option before first receiving input through the input unit 160 to change the likely option. More specifically, the specific-option-display control unit 202h receives a signal from the option-display control unit 202g, and displays an option in the center cell on a certain table as the first likely option so that the option is distinguishable from other options by, for example, placing the selection cursor on the option. In response to input to change the likely option through the input unit 160, the specific-option-display control unit 202h changes the likely option and displays the new one as a currently designated likely option in distinction from other options. In response to input to change a selected area (table) through the input unit 160, the specific-option-display control unit 202h changes the selected area and displays the currently designated selected area in distinction from other areas. That is, the input unit 160 receives an instruction to change a selected area, in addition to instructions to move the selection cursor and select an option. In response to input through the input unit 160 to select an option, the specific-option-display control unit 202h outputs the option that is currently designated as a likely option to the applications 201 as a result of selection.

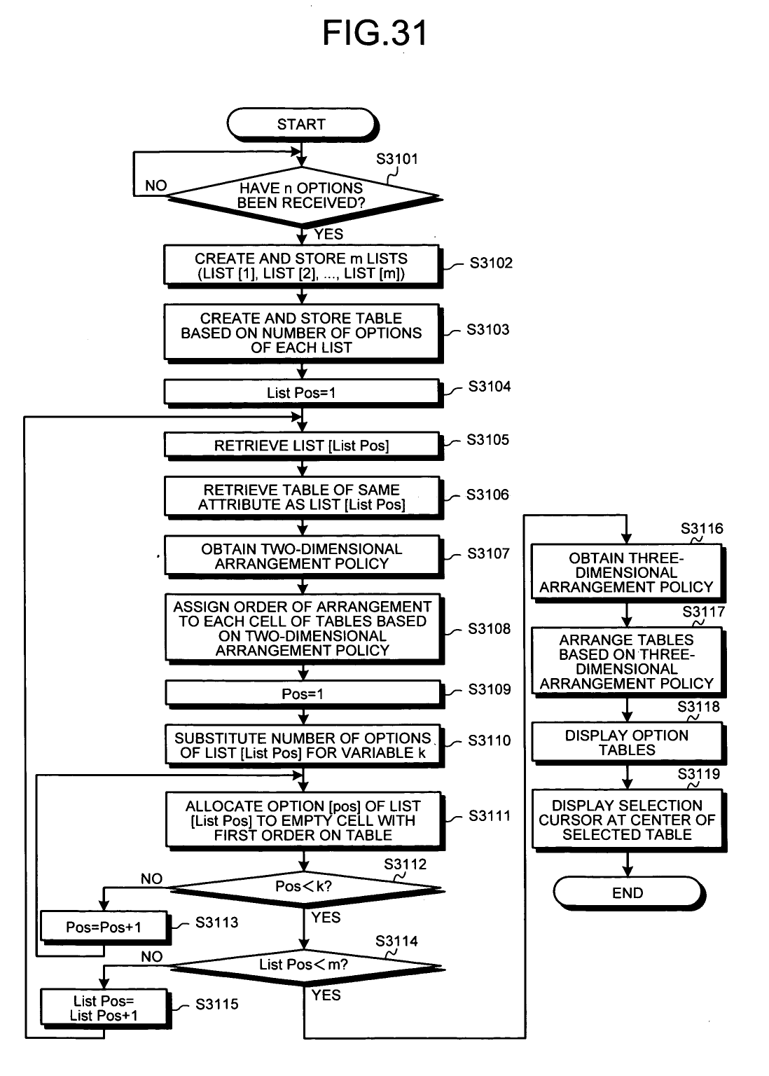

FIG. 31 is a flowchart of the operation of the display control unit 202. In the display control unit 202, when the option input unit 202a receives n options assigned priorities (Yes at step S3101), the option input unit 202a outputs the n options together with priority information to the list creating unit 202b.

When receiving the n prioritized options from the option input unit 202a, the list creating unit 202b sorts the options into m attributes based on specific rules, then sorts them based on the priority information with respect to each attribute, and creates m lists (LIST [1], LIST [2], . . . , LIST [m]). The lists are stored in the option-display storage unit 192 (step S3102). The list creating unit 202b also outputs information on the total number of the options in the lists to the table creating unit 202c. Here, ListPos denotes a variable to be used in the process performed by the option arranging unit 202e. The LIST [ListPos] indicates a list with a [ListPos] number (e.g., the LIST [1] is the first list) in the lists.

When receiving the information on the number of the options from the list creating unit 202b, the table creating unit 202c creates a table for each attribute, in which the center cell is determined, based on the information, and stores all tables in the option-display storage unit 192 (step S3103).

The option arranging unit 202e substitutes default value 1 for the variable ListPos (step S3104), and retrieves the LIST [1] and a table having the same attribute as that of the LIST [1] from the option-display storage unit 192 (steps S3105 and S3106). The option arranging unit 202e obtains a two-dimensional arrangement policy from the two-dimensional policy storage unit 192a (step S3107), and sequentially arranges the options based on the two-dimensional arrangement policy (steps S3108 to S3113).

When all the m lists and all the tables having the same attributes as the m lists have not yet been read out (No at step S3114), the option arranging unit 202e increments the variable ListPos by one until the options on all the m lists are allocated onto the tables of corresponding attributes (steps S3105 to S3115).

When all the options are allocated onto the corresponding tables (Yes at step S3114), the option arranging unit 202e stores the option tables thus obtained in the option-display storage unit 192, and outputs a signal to the table arranging unit 202f to instruct it to arrange the option tables.

Upon receiving the signal from the option arranging unit 202e, the table arranging unit 202f obtains a three-dimensional arrangement policy from the three-dimensional policy storage unit 192b (step S3116), and arranges the option tables retrieved from the option-display storage unit 192 based on the three-dimensional arrangement policy. The arranged option tables are stored in the option-display storage unit 192 (step S3117). The table arranging unit 202f outputs a signal to the option-display control unit 202g to instruct it to display the arranged option tables.

Upon receipt of the signal from the table arranging unit 202f, the option-display control unit 202g retrieves the arranged option tables from the option-display storage unit 192 to output it to the output unit 170. Thus, the arranged option tables are displayed (step S3118), where the selection cursor is positioned on the center cell of predetermined one of the option tables by the specific-option-display control unit 202h (step S3119), and the process ends.

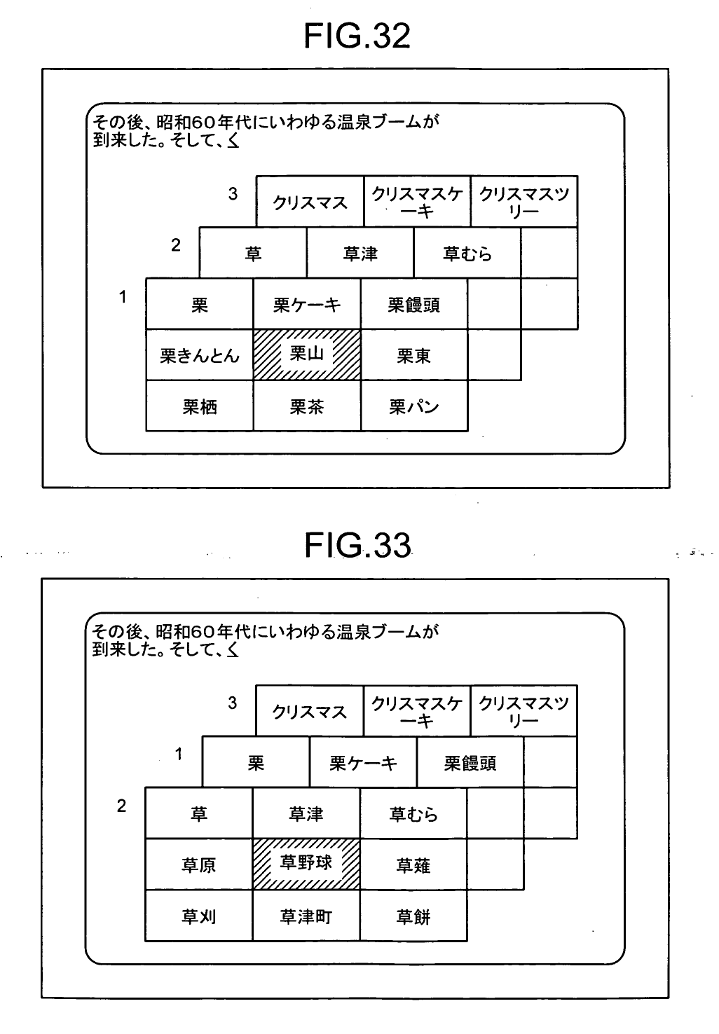

FIGS. 32 to 37 are examples of screen displays of the output unit 170. When the user executes, for example, a word-processing application and inputs characters, the information processing device 150 displays text. When the user inputs a kana letter, the word-processing application generates options with its autocomplete function. After the options are processed by the display control unit 202, the information processing device 150 displays three option tables of different attributes on top of one another, and places the selection cursor on the center cell of the option table displayed on top as shown in FIG. 32. More specifically, the option tables displayed behind are not completely covered by the top table, but are overlapped so that options in the first row can be viewed. Additionally, a number such as 1 is displayed near each of the option tables so that, when a number corresponding to an option table is input through a numeric key, the option table can be displayed on top.

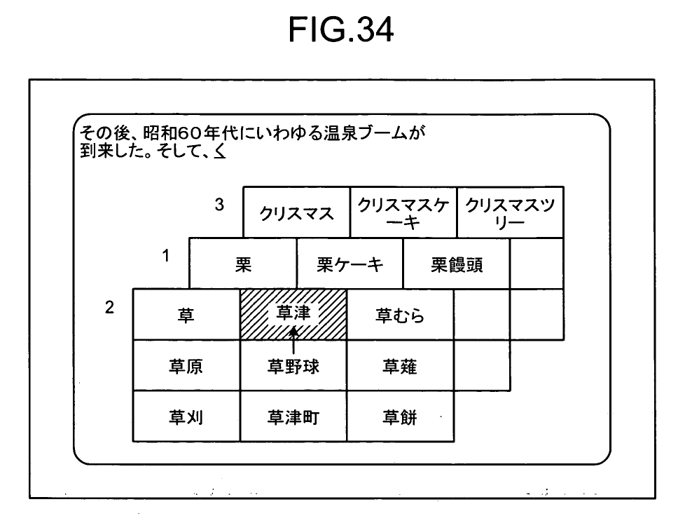

For example, when the user inputs 2 through the numeric key, the information processing device 150 displays the option table 2 on top of the other, and places the selection cursor on the center cell of the table as shown in FIG. 33. Thereafter, when the user provides input, for example, to move the selection cursor up by one cell, the information processing device 150 moves the selection cursor onto an option in the upper cell as shown in FIG. 34. In response to user operation such as pressing the enter key, the option is selected and output to the word-processing application, and the process ends.

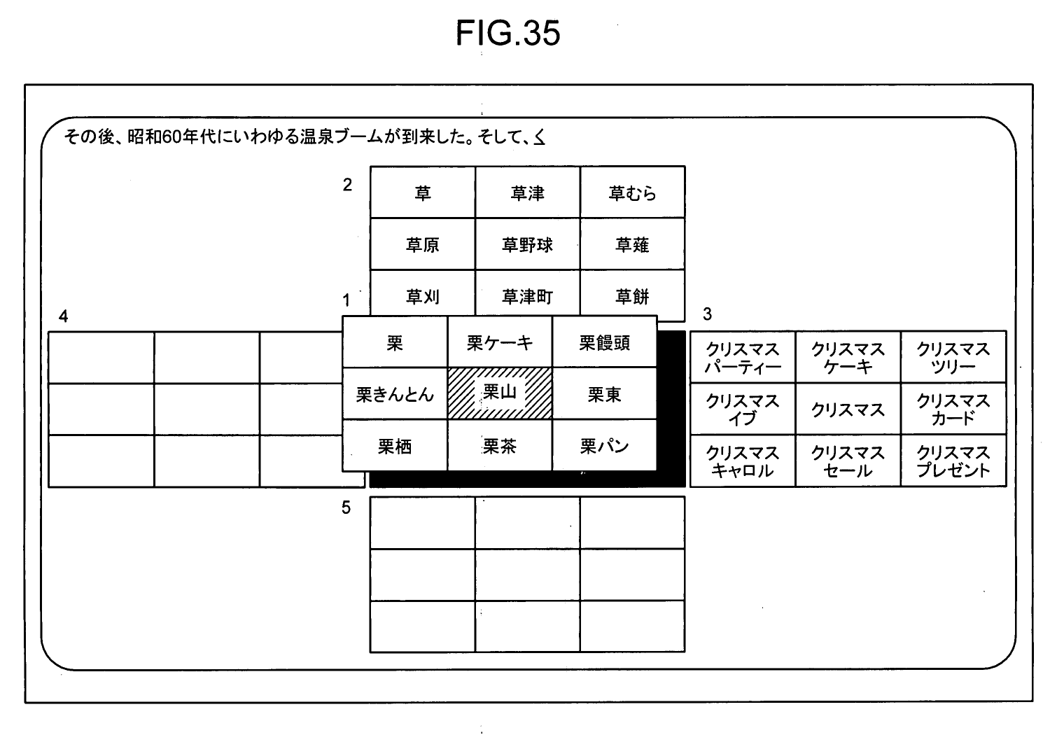

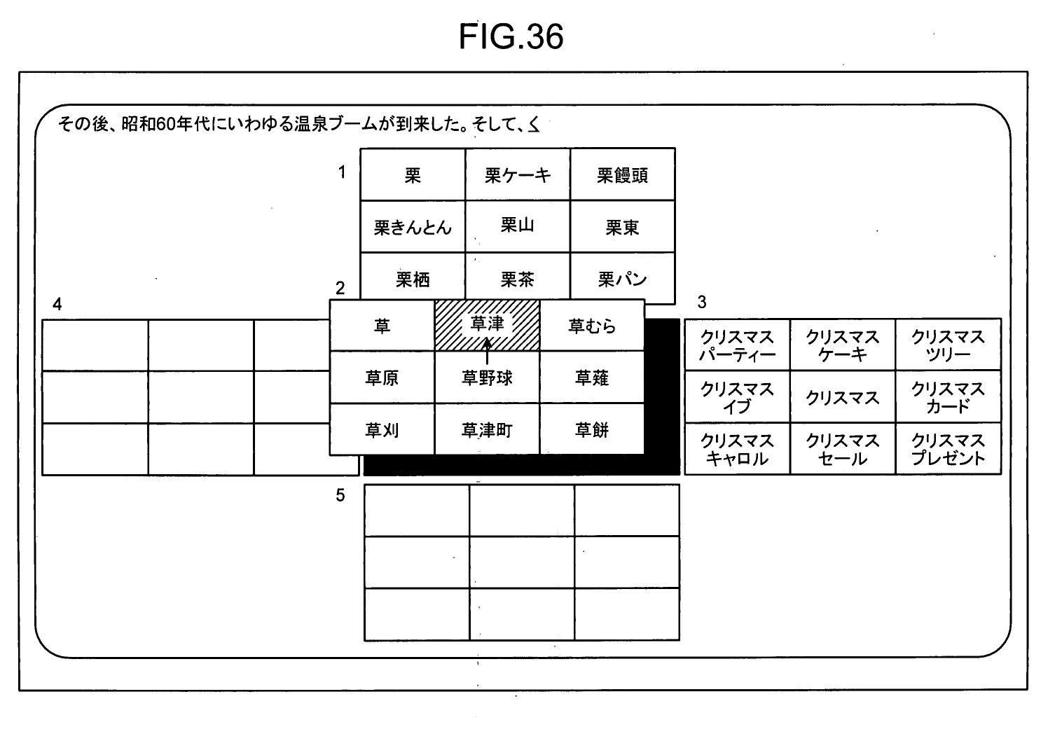

The information processing device 150 also displays option tables as shown in FIG. 35 when a three-dimensional arrangement policy is changed to another. In FIG. 35, the information processing device 150 displays the option table 1 currently designated as a selection area in a three-dimensional fashion to differentiate the table 1 from others, and places the selection cursor on the center cell of the table 1. When the user inputs, for example, 2 through the numeric key and provides input to move the selection cursor up by one cell, the information processing device 150 displays the option table 2 as the currently designated selection area in a three-dimensional fashion as shown in FIG. 36. The selection cursor is moved onto an option in the upper cell of the option table 2. In response to user operation such as pressing the enter key, the option is selected and output to the word-processing application, and the process ends.

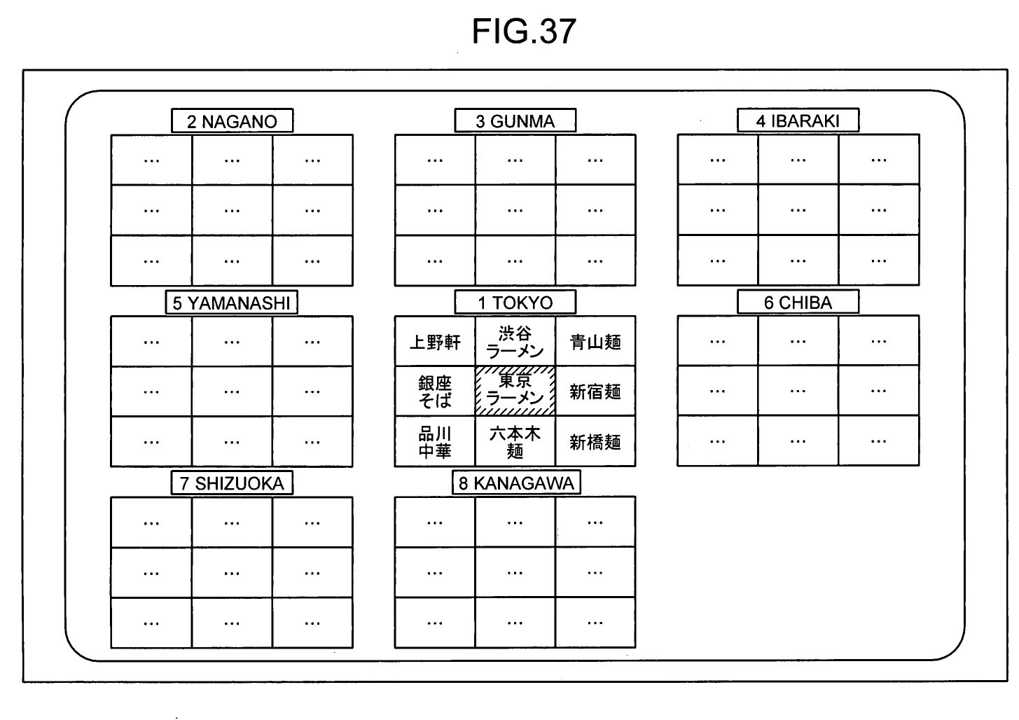

In still another example, when options are generated as a result of search for, for example, noodle restaurants in a certain area, the information processing device 150 sorts the options by an attribute such as prefecture (in FIG. 37, a table is created for eight prefectures: Tokyo, Nagano, Gunma, Ibaraki, Yamanashi, Chiba, Shizuoka, and Kanagawa) and creates a different table for each prefecture as shown in FIG. 37. The tables can be arranged to indicate the positional relationship between the prefectures, and displayed on the output unit.

As described above, according to the sixth embodiment, options are sorted into different areas according to their attributes and displayed on the display unit. In each area, predetermined one of the options is arranged in the predetermined center position, while the rest are arranged radially around the center option. Before the user first provides input to move the selection cursor through the input unit, an option arranged in the center of one of the areas is distinguishably displayed as a likely option on the display unit. When there are a large number of options, if options are displayed separately according to their attribute, the user can smoothly find a desired option and select the option with fewer operations compared to the case where options are displayed on a single table.

Moreover, the options that are sorted into different areas are displayed based on an arrangement policy. That is, the options that are sorted by attributes are displayed orderly based on the arrangement policy. Therefore, the user can easily find a target option.

Although example embodiments of the present invention have been described, the present invention is not limited thereto but is susceptible to various changes and modifications. In the following, such modifications will be explained.

### (1) Table

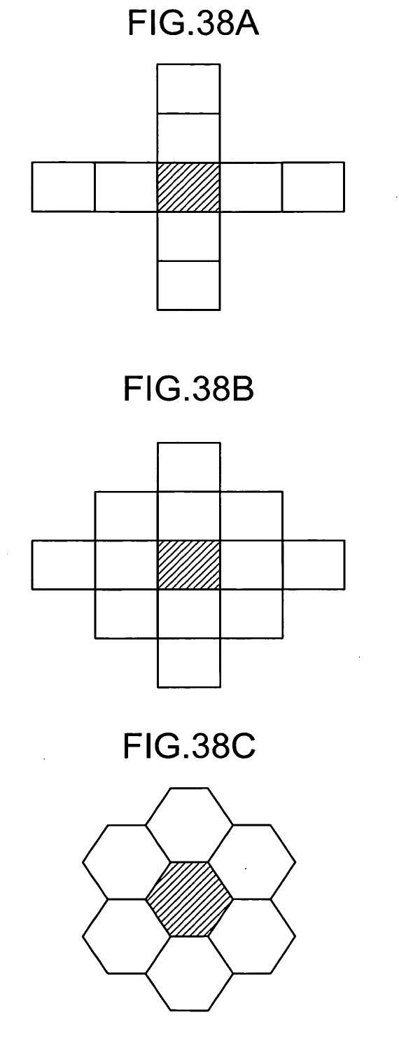

In the first to the sixth embodiments, the table creating unit of the information processing device creates a matrix-type table. However, the present invention is not limited to this. Tables as shown in FIGS. 38A and 38B can be adopted, as long as there is no disparity in the distances between the center cell and each one of the surrounding cells. In either table, the selection cursor can be moved to all the cells with two moving operations at most.

Further, in the first to the sixth embodiments, the table creating unit of the information processing device creates a table on the precondition that the input unit receives moving operations of four directions, upward, downward, left and right. The present invention is not limited to this. As shown in FIG. 38C, the table may be created for a case where the input unit receives moving operations of three directions, upward, lower right, and lower left.

### (2) Selection Cursor

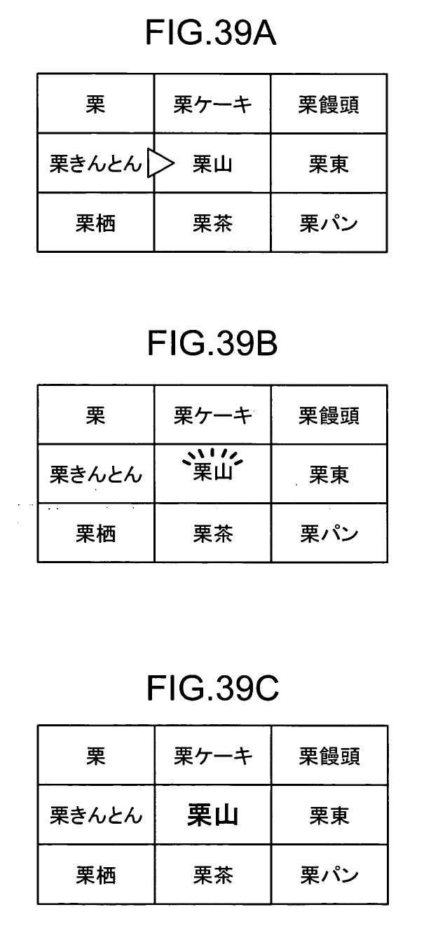

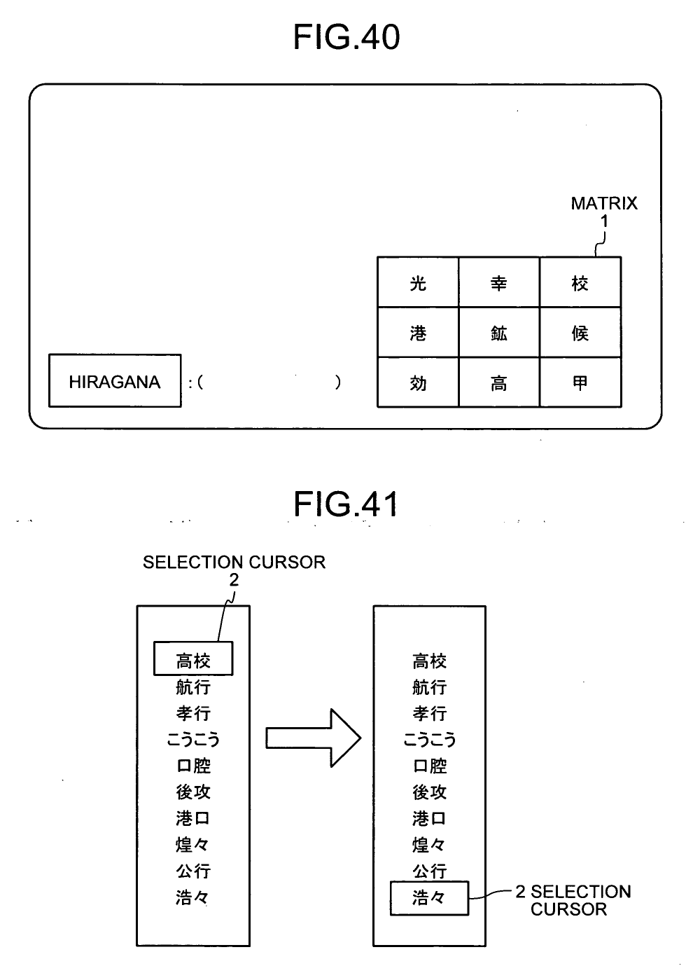

In the first to the sixth embodiments, the specific-option-display control unit of the information processing device displays a selection cursor by shading a cell. The present invention is not limited to this, however. As shown in FIGS. 39A to 39C, a graphic symbol suitable for designating the option as a likely option may be used. Otherwise, the subject option may be designated with flickering light, or displayed in a different font.

### (3) Structure of System and Others

Among the processes explained as being automatically performed in the above embodiments, all or part of them can be manually performed. On the other hand, among the processes explained as being manually performed in the above embodiments, all or part of them can be automatically performed by known methods. In addition, the processing procedures, the controlling procedures, terms of components, information including various data and parameters used in the above description and drawings can be arbitrarily changed except otherwise specified.

The constituent elements of the information processing device (10, 90 and 150) are functionally conceptual, and not necessarily physically configured as illustrated. That is, the arrangement of the respective units is not limited to those shown in the drawings, and can be functionally or physically separated or integrated, partly or wholly, according to the load or usage. For example, the option-display control unit 82e and the specific-option-display control unit 82f can be integrated. Besides, the same function of the information processing device can be entirely or partially realized by central processing unit (CPU), or by a computer program executed by CPU. The information processing device can also be implemented in wired-logic hardware.

### (4) Option Display Program

In the first to the sixth embodiments, the information processing device is explained as hardware; however, it can be implemented as software. In other words, a computer program (hereinafter, “option display program”) can be executed on a computer to realize the same function as the information processing device.

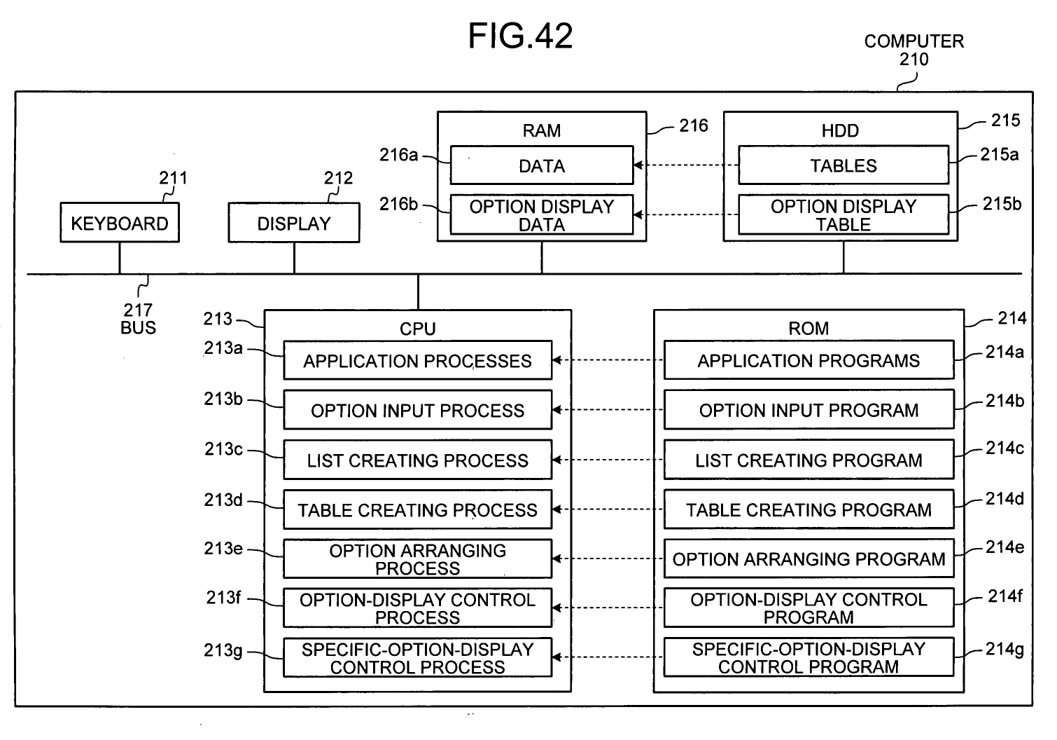

FIG. 42 is a block diagram of a computer 210 that executes the option display program to realize the same function as the information processing device 10. The computer 210 includes a keyboard 211, a display 212, a CPU 213, a read only memory (ROM) 214, a hard disk drive (HDD) 215, a random access memory (RAM) 216, which are connected to one another by a bus 217.

The ROM 214 stores therein option display programs in advance that perform the same functions as the information processing device 10 described in the first embodiment, i.e., application programs 214a, an option input program 214b, a list creating program 214c, a table creating program 214d, an option arranging program 214e, an option-display control program 214f, and a specific-option-display controlling program 214g, as shown in FIG. 42. The programs 214a to 214g can be suitably integrated or separated as with the constituent elements of the information processing device 10 shown in FIG. 2.

The CPU 213 reads the programs 214a to 214g from the ROM 214 and executes them to perform application processes 213a, an option input process 213b, a list creating process 213c, a table creating process 213d, an option arranging process 213e, an option-display control process 213f, and a specific-option-display control process 213g, respectively, as shown in FIG. 42. The processes 213a to 213g correspond to the applications 81, the option input unit 82a, the list creating unit 82b, the table creating unit 82c, the option arranging unit 82d, the option-display control unit 82e, and the specific-option-display control unit 82f shown in FIG. 2, respectively.

The HDD 215 includes tables 215a and an option display table 215b. The tables 215a correspond to the data 71 shown in FIG. 2, while the option display table 215b corresponds to the option-display storage unit 72. The CPU 213 registers various types of data 216a in the tables 215a, and option display data 216b in the option display table 215b. The CPU also retrieves the data 216a and the option display data 216b and stores them in the RAM 216. Based on the data 216a and the option display data 216b stored in the RAM 216, the CPU 213 executes the option display control process and the like.

The programs 214a to 214g are not necessarily be stored in advance in the ROM 214. For example, the programs can be stored in a portable physical medium and loaded therefrom into the computer 210. Examples of such a medium include a flexible disk (FD), a compact disc-read only memory (CD-ROM), an magneto-optical (MO) disk, a digital versatile disk (DVD), and an integrated circuit (IC) card. The programs can also be stored in a fixed physical medium that is provided inside or outside the computer 210, such as an HDD. The programs stored in a different computer (or server) connected to the computer 210 via public line, the Internet, local area network (LAN), or wide area network (WAN) can be downloaded into the computer 210.

As set forth hereinabove, according to an embodiment of the present invention, options are displayed in a selectable manner with a specific option arranged in a predetermined center and others arranged radially around the center option. The option arranged at the center is distinguishable from the others as a likely option when a user first provides input to select an option. In other words, respective options are arranged at nearly the same distance from an option initially specified as a likely option, and fewer operations are required to change the likely option to another. Thus, user operation can be facilitated. Besides, the options are arranged orderly based on predetermined criteria. Therefore, the user can easily find a target option

Moreover, when there are options for a certain place, options are assigned, as attributes, positional information indicating the positions of the options. The options can be displayed indicate the positional relationship between the options. Thus, the user can quickly find a desired option, and intuitively understand the positions of the options.

Furthermore, if there are a large number of options, the options are displayed separately according to their attribute. Therefore, the user can smoothly find a desired option and select the option with fewer operations compared to the case where the options are displayed on a single table.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to display a plurality of options in a selectable manner such that one of the options is distinguishable from others as a specific option while changing the specific option in response to a select input to select an option, the computer program causing the computer to execute:
arranging a first option from among the options at substantially center of other options; and
displaying the first option as the specific option when the select input is first received.

2. The computer-readable recording medium according to claim 1, wherein the arranging includes arranging the options based on an arrangement policy.

3. The computer-readable recording medium according to claim 1, wherein:
the options are assigned, as an attribute, priority that indicates a degree of possibility that each of the options is to be selected; and
the first option is an option with highest priority.

4. The computer-readable recording medium according to claim 1, wherein:
the options have, as an attribute, positional information that indicates a position of each of the options; and
the arranging includes arranging the options based on the positional information with the first option being an option corresponding to a current location.

5. The computer-readable recording medium according to claim 1, wherein:
the options have predetermined attributes;
the arranging includes sorting the options into groups based on the attributes, and arranging a first option from among the options at substantially center of other options in each of the groups; and
the displaying includes displaying the first option in one of the groups as the specific option when the select input is first received.

6. The computer-readable recording medium according to claim 5, wherein the arranging includes arranging the options sorted into the groups based on an arrangement policy.

7. An option display device that displays a plurality of options in a selectable manner such that one of the options is distinguishable from others as a specific option while changing the specific option in response to a select input to select an option received through an input unit, the option display device comprising:
an option arranging unit that arranges a first option from among the options at substantially center of other options; and
a display unit that displays the first option as the specific option when the select input is first received through the input unit.

8. The option display device according to claim 7, further comprising a storage unit that stores an arrangement policy, wherein
the option arranging unit arranges the options based on the arrangement policy.

9. The option display device according to claim 7, wherein:
the options are assigned, as an attribute, priority that indicates a degree of possibility that each of the options is to be selected; and
the first option is an option with highest priority.

10. The option display device according to claim 7, wherein:
the options have, as an attribute, positional information that indicates a position of each of the options; and
the option arranging unit arranges the options based on the positional information with the first option being an option corresponding to a current location.

11. The option display device according to claim 7, wherein:
the options have predetermined attributes;
the option arranging unit sorts the options into groups based on the attributes, and arranges a first option from among the options at substantially center of other options in each of the groups; and
the display unit displays the first option in one of the groups as the specific option when the select input is first received through the input unit.

12. The option display device according to claim 11, wherein the option arranging unit arranges the options sorted into the groups based on an arrangement policy.

13. An option display method for displaying a plurality of options in a selectable manner such that one of the options is distinguishable from others as a specific option while changing the specific option in response to a select input to select an option, the option display method comprising:
arranging a first option from among the options at substantially center of other options; and
displaying the first option as the specific option when the select input is first received.

14. The option display method according to claim 13, wherein the arranging includes arranging the options based on an arrangement policy.

15. The option display method according to claim 13, wherein:
the options are assigned, as an attribute, priority that indicates a degree of possibility that each of the options is to be selected; and
the first option is an option with highest priority.

16. The option display method according to claim 13, wherein:
the options have, as an attribute, positional information that indicates a position of each of the options; and
the arranging includes arranging the options based on the positional information with the first option being an option corresponding to a current location.

17. The option display method according to claim 13, wherein:
the options have predetermined attributes;
the arranging includes sorting the options into groups based on the attributes, and arranging a first option from among the options at substantially center of other options in each of the groups; and
the displaying includes displaying the first option in one of the groups as the specific option when the select input is first received.

18. The option display method according to claim 17, wherein the arranging includes arranging the options sorted into the groups based on an arrangement policy.
